(19) United States
(12) Patent Application Publication
(10) Pub. No.: US 2026/0064023 A1
(43) Pub. Date: Mar. 5, 2026

(54) DEVELOPING APPARATUS, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: YOSHIAKI SHIOTARI, Shizuoka (JP); SHINTARO NOJI, Shizuoka (JP); KANA SATO, Shizuoka (JP); ATSUSHI NOGUCHI, Shizuoka (JP)

(21) Appl. No.: 19/304,809

(22) Filed: Aug. 20, 2025

(30) Foreign Application Priority Data
Aug. 27, 2024 (JP) 2024-145555

(51) Int. Cl. G03G 9/093; G03G 9/08; G03G 15/08; G03G 21/18

(52) U.S. Cl. CPC G03G 9/09364; G03G 9/0823; G03G 9/09314; G03G 15/0808; G03G 21/1814; G03G 2215/0604

(57) ABSTRACT

A developing apparatus including a developing roller and a toner is provided, in which the toner includes a toner particle containing a crystalline material, the toner has a resistivity of not more than 2.00×10¹⁴ Ω·m at a frequency of 0.01 Hz, obtained by AC impedance measurement, the developing roller includes a substrate having a conductive outer surface and a resin layer on the outer surface of the substrate, the developing roller has an impedance Z of at least 1.00×10⁴ Ω at a frequency of 1.0×10² Hz, obtained by AC impedance measurement, the developing roller has a phase θ1 of −40° to −10° at a frequency of 1.0×10² Hz, obtained by AC impedance measurement, and the developing roller has a phase not more than θ2 of −60° at a frequency of 1.0×10⁴ Hz, obtained by AC impedance measurement is.

### BACKGROUND

### Field of the Technology

The present disclosure relates to a developing apparatus, a process cartridge, and an electrophotographic image forming apparatus.

### Description of the Related Art

Products that are smaller in size and can be easily maintained and managed are required as image forming apparatuses such as copying machines and printers. From such a viewpoint, one-component developing methods are preferably used.

With recent high environmental awareness, products that support energy saving more than ever are required. For contributing to energy saving as toners, studies have been progressively made to lower the fixation temperatures of toners, and in particular, technical studies have been made to apply thereto the sharp melt properties of crystalline materials and crystalline resins.

For example, U.S. Patent Application Publication No. 2017/0131653 proposes a toner containing a large amount of crystalline resin.

Although the toner containing a large amount of a crystalline resin has a lower fixation temperature, the resistance of the toner is decreased due to the influence of the large amount of crystalline material. As a result, the toner may obtain insufficient charge quantity, thereby causing problems such as image fogging.

In this regard, examples of the means for allowing a toner to obtain a sufficient charge quantity include Japanese Patent Application Publication No. 2022-080159. In addition, examples of the means for remedying image fogging due to a small charge quantity of a toner include Japanese Patent Application Publication No. 2000 206777.

According to studies of the inventors, however, in Japanese Patent Application Publication No. 2022-080159, due to the insufficient resistance design of a developing roller, the toner on the developing roller may leak through the developing roller at the time of passing through the nip of regulating member on the developing roller, thereby causing adverse effects such as fogging and toner scattering.

In addition, in Japanese Patent Application Publication No. 2000-206777, the resistance value of a developing roller is increased to maintain the charge of the toner on the developing roller. However, merely increasing the resistance value is likely to result in significant charge-up of the surface of the developing roller at the time of continuous printing, and thus, the adhesion of the toner to the surface of the developing roller may become excessively strong. As a result, when printing at high image density is continued consecutively, adverse effects such as a reduced image density may be caused.

As described above, there is still room for studying charge stabilization in a developing device for a toner that contains a large amount of crystalline material and that has excellent low-temperature fixability.

### SUMMARY

The present disclosure provides a developing apparatus having high charge stability, in which a toner that is excellent in low-temperature fixability is used.

The present disclosure relates to a developing apparatus comprising a developing roller and a toner, wherein the toner comprises a toner particle comprising a crystalline material, the toner has a resistivity of not more than 2.00×10¹⁴ Ω·m at a frequency of 0.01 Hz, obtained by AC impedance measurement, the developing roller comprises a substrate having a conductive outer surface, and a resin layer on the outer surface of the substrate, the developing roller has an impedance Z of at least 1.00×10⁴ Ω at a frequency of 1.0×10² Hz, obtained by AC impedance measurement, the developing roller has a phase θ1 of −40° to −10° at a frequency of 1.0×10² Hz, obtained by AC impedance measurement, and the developing roller has a phase θ2 of not more than −60° at a frequency of 1.0×10⁴ Hz, obtained by AC impedance measurement.

The present disclosure relates to a process cartridge configured to be attachable to and detachable from a main body of an electrophotographic image forming apparatus, in which the process cartridge includes the developing apparatus.

The present disclosure relates to an electrophotographic image forming apparatus, in which the electrophotographic image forming apparatus includes the developing apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view illustrating an example of a developing roller.

FIG. 2 is a schematic sectional view illustrating another example of a developing roller.

FIG. 3 is a schematic view of a process cartridge.

FIG. 4 is a schematic view of an electrophotographic image forming apparatus.

FIG. 5 is a schematic view of a measurement electrode formed on a developing roller.

FIG. 6 is a sectional view of a developing roller and a measurement electrode.

FIG. 7 is a schematic view of an impedance measurement system.

FIG. 8 is a schematic view illustrating an example of an apparatus for measuring the surface potential of a developing roller.

FIG. 9 is a schematic diagram of a circuit for measuring a leakage current flowing from a toner to a developing roller.

FIG. 10 is a schematic view of an electrophotographic image forming apparatus for image evaluation.

### DESCRIPTION OF THE EMBODIMENTS

Unless otherwise specified, descriptions of numerical ranges such as “from XX to YY” or “XX to YY” in the present disclosure include the numbers at the upper and lower limits of the range. When numerical ranges are described in stages, the upper and lower limits of each of each numerical range may be combined arbitrarily. In the present disclosure, wording such as “at least one selected from the group consisting of XX, YY and ZZ” means any of: XX; YY; ZZ; a combination of XX and YY; a combination of XX and ZZ; a combination of YY and ZZ; or a combination of XX and YY and ZZ.

The term “monomer unit” refers to a reacted form of a monomer substance in a polymer. For example, one carbon-carbon bond segment in a main chain of a polymer formed by polymerizing vinyl-based monomers is defined as one unit. The vinyl-based monomer can be represented by the following formula (6).

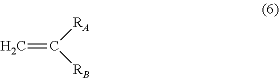

In the formula (6), R_{A} represents a hydrogen atom or an alkyl group (preferably an alkyl group having 1 to 3 carbon atoms, more preferably a methyl group), and R_{B} represents an optional substituent.

In addition, in the present disclosure, the crystalline resin refers to a resin that exhibits a clear endothermic peak in differential scanning calorimeter (DSC) measurement.

In order to satisfy the low-temperature fixability, the resistivity of a toner described later, obtained by AC impedance measurement method for the toner, needs to be 2.00×10¹⁴ Ω·m or less. As described above, the crystalline material has, due to its regular arrangement, a lower electrical resistance than an amorphous material. When the resistivity of the toner exceeds 2.00×10¹⁴ Ω·m, no favorable low-temperature fixability can be achieved due to the insufficient crystalline material in the toner.

The resistance value of the toner is preferably from 1.00×10¹² to 2.00×10¹⁴ Ω·m, more preferably from 1.00×10¹³ to 6.00×10¹³ Ω·m. The resistance value of the toner can be controlled with the amount of the crystalline material and the dispersion state of the crystalline material. In addition, the resistance value can be controlled with the resistance value of the external additive and the amount of coating the toner surface with the external additive.

In contrast, the toner with the low resistivity of 2.0×10¹⁴ Ω·m or less is less likely to retain electric charge. As a result of intensive study by the inventors for retaining the electric charge of the toner that is less likely to retain the electric charge, the inventors have found that it is important for the phase θ2 of a developing roller described later to be −60° or less at a frequency 1.0×10⁴ Hz in an AC impedance measurement method. The phase θ2 is −60° or less, thereby allowing charge leakage between the toner and the developing roller to be suppressed, and allowing image fogging to be reduced.

The phase at each frequency, obtained by the AC impedance measurement method, represents the insulator characteristics and conductor characteristics of an object to be measured at the frequency. The phase represents the deviation of an output current waveform with respect to an input current waveform, and the phases of −90°, 0°, and +90° respectively indicate a capacitor behavior, a resistance behavior, and an inductance behavior. The phase between 0° and −90° indicates an equivalent circuit including elements a resistance and a capacitor. In a common one-component developing system, the ON-OFF period of the voltage around 1.0×10⁴ Hz corresponds to the time during which the toner on the developing roller is rubbed when the toner passes through a regulating member.

Thus, as the electrical characteristics of the developing roller at the frequency of 1.0×10⁴ Hz are closer to a capacitor-like behavior, the electric charge on the surface of the toner is less likely to leak toward the developing roller. When the range of the phase θ2 exceeds −60°, a stronger resistance-like behavior makes the developing roller more likely to leak electric charge, and the electric charge of the toner, which is less likely to be retained, easily leaks toward the developing roller, thereby causing image fogging.

From the viewpoint of further suppressing image fogging, the value of phase θ2 is preferably −70° or less. The phase θ2 is preferably from −90° to −60°, more preferably from −85° to −70°, still more preferably from −82° to −75°.

The value of the phase θ2 can be increased, for example, by increasing the amount of conductive fine particles added. In addition, the value of phase θ2 can be reduced by reducing the amount of conductive fine particles added or using an ionic conducting agent, for example.

In addition, in order to suppress the charge-up of the developing roller due to continuous printing, the phase θ1 of the developing roller at a frequency of 1.0×10² Hz, obtained by AC impedance measurement, needs to be from −40° to −10°. In the present disclosure, it is important to control the phase θ1 within a range from −40° to −10°, with the phase θ2 in range mentioned above. As the behavior at a lower frequency is closer to a resistance-like behavior, the accumulation of electric charge into the developing roller can be relaxed, and thus, the charge-up of the developing roller due to continuous printing can be suppressed. As a result, the decrease in image density due to the insufficient development of the toner onto a photosensitive member can be reduced.

It is to be noted that the reason for the frequency of 1.0×10² Hz is because the time corresponds to the time during which the toner carried on the developing roller passes through a regulating blade part, and thus corresponds to the ON-OFF time of the circuit.

From the viewpoint of further improving the image density, the phase θ1 is preferably from −37° to −13°, more preferably from −32° to −20°, still more preferably from −32° to −25°.

The value of the phase θ1 can be increased, for example, by controlling the dispersibility of the conductive fine particles. In addition, the value of the phase θ1 can be reduced, for example, by reducing the amount of conductive fine particles added or using ionic conductivity in place of the conductive fine particles. Rc, σc/Rc, d, and σd/d within the preferred ranges described later make it easy to control the phase θ1 within the range mentioned above.

It is necessary for the value of the impedance Z at a frequency of 1.0×10² Hz to be 1.00×10⁴ Ω or more while the two conditions mentioned above are satisfied, for exhibiting the characteristics represented by the phases θ1 and θ2. The value of the impedance Z is preferably as high as possible, and the upper limit thereof is not particularly limited, but is, for example, 1.00×10⁸ Ω or less. The impedance Z is, for example, from 1.00×10⁴ to 1.00×10⁸ Ω, preferably from 1.00×10⁵ to 5.00×10⁷ Ω, more preferably from 5.00×10⁵ to 1.00×10⁷ Ω.

The impedance Z can be controlled with, for example, conductive fine particles of a resin layer, which will be specifically described later.

As described above, the use of the toner that has a low resistivity and a large amount of crystalline material, with the phases θ1, the phase θ2, and the impedance Z within specific ranges allows a developing apparatus to be obtained, which suppresses image fogging and reduce a decrease in image density with high charge stability. Hereinafter, the present disclosure will be further described.

### Toner

The toner has an endothermic quantity obtained by the differential scanning calorimetric measurement described in the section of measurement method, for example, from 18 to 70 J/g, preferably from 20 to 70 J/g in view of improving the low-temperature fixability, the hot offset, and furthermore, the heat-resistant storability. The endothermic quantity is more preferably from 20 to 40 J/g. The endothermic quantity of the toner can be controlled by adjusting the amount of the crystalline material added or the compatibility of the crystalline material with the resin.

From the viewpoint of efficiently plasticizing the binder resin at the time of fixing, the melting temperature of the crystalline material is preferably lower. Thus, the temperature of an endothermic peak of the toner, obtained by differential scanning calorimetric measurement, is preferably from 40° C. to 75° C., more preferably from 60° C. to 75° C. The temperature of the endothermic peak can be controlled with the melting point of the crystalline material.

Furthermore, the low-temperature fixability can be further improved as more materials are melted to give an effect. Thus, the endothermic quantity of the toner at 30° C. to 80° C., obtained by differential scanning calorimetric measurement, is preferably from 20 to 70 J/g, more preferably from 22 to 50 J/g. The endothermic quantity of the toner at 30° C. to 80° C. can be controlled with the melting point of the crystalline material, or annealing treatment conditions for growth of crystals of the crystalline material.

Such a crystalline material is preferably used in combination with an amorphous resin. Accordingly, the crystalline material preferably contains at least one selected from the group consisting of a crystalline resin and an ester wax from the viewpoint of compatibility with the amorphous resin at the time of melting.

The amorphous resin and the crystalline material preferably form a sea-island structure in a cross section of the toner. In the case of using an ester wax as the crystalline material, the effect of plasticizing the amorphous resin can be enhanced by increasing the area of contact between the ester wax and the amorphous resin, and thus, it is preferable to have a sea-island structure in which the ester wax dispersed in an island shape in the toner cross section of described later. The size of the island of the sea-island structure is preferably smaller.

More specifically, the crystalline material preferably contains an ester wax, and the toner particle preferably further contains the amorphous resin. Further, when the cross section of the toner is observed with a scanning transmission electron microscope, the amorphous resin and the ester wax form a sea-island structure in the cross section of the toner. For the sea-island structure, for example, in the cross section of the toner, the amorphous resin forms a continuous sea, and the crystalline material (for example, ester wax) is dispersed in the amorphous resin to form islands.

In the case of using a crystalline resin as the crystalline material, the crystalline resin preferably contains a monomer unit represented by the following formula (1). Furthermore, the toner particle preferably further contains the amorphous resin. The crystalline resin containing the monomer unit represented by the formula (1) is preferred from the viewpoints of low-temperature fixability and hot offset resistance, because the crystalline resin is likely to be phase-separated from the amorphous resin when the crystalline material is crystallized and likely to be compatible with the amorphous resin when the crystalline material is melted.

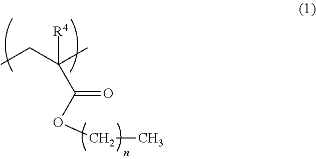

In the formula (1), R⁴ represents a hydrogen atom or a methyl group, and n represents an integer from 15 to 35.

As a method for introducing the monomer unit represented by formula (1) into the crystalline resin, there is, for example, a method of polymerizing the following (meth)acrylic ester. Examples thereof include a stearyl (meth)acrylate, a nonadecyl (meth)acrylate, an eicosyl (meth)acrylate, a heneicosanyl (meth)acrylate, a behenyl (meth)acrylate, a lignoceryl (meth)acrylate, a ceryl (meth)acrylate, an octadecyl (meth)acrylate, and a myrisyl (meth)acrylate.

The crystalline resin may have only one type monomer unit or two or more monomer units represented by formula (1).

The content ratio of the units in the crystalline resin is preferably from 40.0% by mass to 90.0% by mass. The content ratio is more preferably from 45.0% by mass to 85.0% by mass, still more preferably from 50.0% by mass to 80.0% by mass. Within this range, the crystalline resin is more excellent in the balance between low-temperature fixability and anti-hot offset property.

The crystalline resin may have, in addition to the monomer unit represented by formula (1), another monomer unit other than the monomer unit represented by formula (1). As a method for introducing another monomer unit into the crystalline resin, there is, for example, a method of polymerizing the (meth)acrylic ester described above and another vinyl-based monomer.

Examples of the other vinyl-based monomer include the following.

Styrene, α-methylstyrene, and (meth)acrylic esters such as a methyl (meth)acrylate, an ethyl (meth)acrylate, an n-butyl (meth)acrylate, a t-butyl (meth)acrylate, and a 2-ethylhexyl (meth)acrylate;

A monomer having a urea group: for example, a monomer obtained by reacting an amine having 3 to 22 carbon atoms [a primary amine (such as normal-butylamine, t-butylamine, propylamine, and isopropylamine), a secondary amine (such as di-normal-ethylamine, di-normal-propylamine, and di-normal-butylamine), aniline, cycloxylamine, and the like] with an isocyanate having 2 to 30 carbon atoms having an ethylenically unsaturated bond by a known method;

A monomer having a carboxyl group; for example, a methacrylic acid, an acrylic acid, or a 2-carboxyethyl (meth)acrylate; a monomer having a hydroxy group: for example, a 2-hydroxyethyl (meth)acrylate, a 2-hydroxypropyl (meth)acrylate, or the like; a monomer having an amide group; for example, an acrylamide or a monomer obtained by reacting an amine having 1 to 30 carbon atoms with a carboxylic acid having 2 to 30 carbon atoms having an ethylenically unsaturated bond (such as an acrylic acid or a methacrylic acid) by a known method; a monomer having a lactam structure; and N-vinyl-2-pyrrolidone.

Among these monomers, the monomer having a lactam structure is preferred, and N-vinyl-2-pyrrolidone is more preferred. Containing the monomer unit having a lactam structure improves the affinity between the crystalline resin and paper, thereby making it easy to improve the scratch resistance of a fixed image.

More specifically, the crystalline resin preferably contains a monomer unit having a lactam structure. The crystalline resin more preferably contains a monomer unit having a five-membered lactam structure.

The monomer unit having a lactam structure is preferably represented by the following formula (L) (more preferably, formula (L-1)).

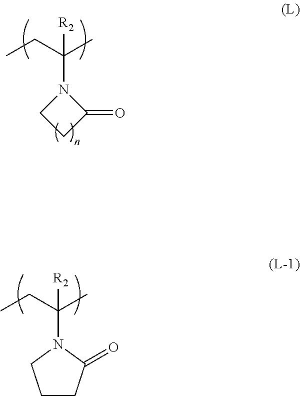

In the formulas (L) and (L-1), R₂ represents a hydrogen atom or a methyl group. n is an integer from 1 to 4 (preferably from 1 to 3).

The content ratio of the monomer unit having a lactam structure in the crystalline resin is preferably from 2.0% by mass to 15.0% by mass.

For the crystalline resin, a crystalline vinyl resin is synthesized by copolymerizing a (meth)acrylic ester and another vinyl-based monomer for introducing the unit, and then can be further reacted with yet another vinyl-based monomer in accordance with a hydrogen abstraction reaction. The hydrogen abstraction reaction is a reaction in which a hydrogen atom bound to a carbon atom is drawn to generate a radical, and other vinyl monomers can be further reacted from the generated radical. Thus, the units in the crystalline vinyl resin can form a more aggregated state in the molecule, thereby making the crystallinity likely to be enhanced.

The content ratio of the crystalline material in the toner particle is, for example, from 15% by mass to 55% by mass, preferably from 20% by mass to 50% by mass, more preferably from 22% by mass to 45% by mass.

The content ratio of the crystalline resin in the toner particle is, for example, from 15% by mass to 50% by mass, preferably from 20% by mass to 45% by mass, more preferably from 30% by mass to 40% by mass.

The content ratio of the ester wax in the toner particles is, for example, from 5% by mass to 35% by mass, preferably from 5% by mass to 30% by mass.

The toner including the crystalline material in a large amount as presented in any of the foregoing may have a resistance decreased by a percolation phenomenon inside the toner caused with the increased crystalline material in the toner. As an approach for increasing the resistance from the toner side, the area proportion of the crystalline material in a cross section of the toner in observing the cross section of the toner with a scanning transmission electron microscope is, for example, 34% or less, preferably 30% or less. The area proportion is, for example, from 10% to 34%, preferably from 10% to 30%, more preferably from 20% to 30%.

Each of the components constituting the toner and a method for producing the toner will be described in more detail.

### Binder Resin

The toner particle may have a binder resin. The crystalline resin and/or amorphous resin described above may be a binder resin.

Examples of the binder resin can include the following resins or polymers as a polyester resin, a vinyl-based resin, and other binder resins. The examples include a styrene acrylic resin, a polyester resin, an epoxy resin, a polyurethane resin, a polyamide resin, a cellulose resin, a polyether resin, and a mixed resin thereof or a composite resin thereof.

Because of inexpensiveness, easy availability, excellence in low-temperature fixability, the binder resin is preferably a polyester resin, a styrene acrylic resin, or a hybrid resin thereof, more preferably a styrene acrylic resin. The amorphous resin is preferably a styrene acrylic resin.

The polyester resin is obtained by selecting and then combining preferred compounds from among polycarboxylic acids, polyols, hydroxycarboxylic acids, and the like, and synthesizing the resin with the use of a conventionally known method such as a transesterification method or a polycondensation method, for example.

The polycarboxylic acids are compounds containing two or more carboxy groups in one molecule. Among the compounds, the dicarboxylic acid is a compound containing two carboxy groups in one molecule, and is preferably used.

Examples of the dicarboxylic acid include dicarboxylic acids such as oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylene diacetic acid, m-phenylene diacetic acid, o-phenylene diacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracene dicarboxylic acid, and cyclohexane dicarboxylic acid.

Examples of the polycarboxylic acids other than the dicarboxylic acid include trimellitic acid, trimesic acid, pyromellitic acid, naphthalene tricarboxylic acid, naphthalene tetracarboxylic acid, pyrene tricarboxylic acid, pyrene tetracarboxylic acid, itaconic acid, glutaconic acid, n-dodecyl succinic acid, n-dodecenyl succinic acid, isododecyl succinic acid, isododecenyl succinic acid, n-octyl succinic acid, and n-octenyl succinic acid. One of these compounds may be used alone, or two or more thereof may be used in combination.

The polyols are compounds containing two or more hydroxyl groups in one molecule. Among the compounds, the diol is a compound containing two hydroxyl groups in one molecule, and is preferably used.

Specific examples thereof include ethylene glycol, diethylene glycol, triethylene glycol, 1,2-propylene glycol, 1,3-propylene glycol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanediol, diethylene glycol, triethylene glycol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, 1,4-cyclohexanediol, polytetramethylene glycol, hydrogenated bisphenol A, bisphenol A, bisphenol F, bisphenol S, and alkylene oxide (ethylene oxide, propylene oxide, butylene oxide, and the like) adducts of the bisphenols.

Among these compounds, the alkylene glycols having 2 to 12 carbon atoms and the alkylene oxide adducts of the bisphenols are preferred, and the alkylene oxide adducts of the bisphenols and combinations thereof with the alkylene glycols having 2 to 12 carbon atoms are particularly preferred.

Examples of the trivalent or higher polyol include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and alkylene oxide adducts of the trivalent or higher polyphenols. One of these compounds may be used alone, or two or more thereof may be used in combination. The polyester resin may be a polyester resin containing a urea group. The polyester resin preferably has carboxy groups uncapped at the terminal and the like.

Examples of the styrene acrylic resin include homopolymers made from the following polymerizable monomers, copolymers obtained from two or more of the monomers in combination, or mixtures thereof.

Styrene, styrene-based monomers such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; (meth)acrylic monomers such as methyl (meth)acrylate, ethyl(meth) acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate, 2-benzoyloxyethyl (meth)acrylate, (meth) acrylonitrile, 2-hydroxyethyl (meth)acrylate, (meth)acrylic acid, and maleic acid; vinyl ether-based monomers such as vinyl methyl ether and vinyl isobutyl ether; vinyl ketone-based monomers such as vinyl methyl ketone, vinyl ethyl ketone, and vinyl isopropenyl ketone; and polyolefins such as ethylene, propylene, and butadiene.

As the styrene acrylic resin, a polyfunctional polymerizable monomer can be used, if necessary. Examples of the polyfunctional polymerizable monomer include diethylene glycol di(meth)acrylate, triethylene glycol di(meth)acrylate, tetraethylene glycol di(meth)acrylate, polyethylene glycol di(meth)acrylate, 1,6-hexandiol di(meth)acrylate, neopentyl glycol di(meth)acrylate, tripropylene glycol di(meth)acrylate, polypropylene glycol di(meth)acrylate, 2,2′-bis(4-((meth)acryloxy diethoxy)phenyl)propane, trimethylolpropane tri(meth)acrylate, tetramethylolmethane tetra(meth)acrylate, divinylbenzene, divinylnaphthaline, divinyl ether.

In addition, it is also possible to further add known chain transfer agents and polymerization inhibitors to control the degree of polymerization.

Examples of polymerization initiators for obtaining styrene acrylic resins include organic peroxide-based initiators and azo-based polymerization initiators.

Examples of the organic peroxide-based initiators include benzoyl peroxide, lauroyl peroxide, di-α-cumyl peroxide, 2,5-dimethyl-2,5-bis(benzoylperoxy)hexane, bis(4-t-butylcyclohexyl)peroxydicarbonate, 1,1-bis(t-butylperoxy)cyclododecane, t-butylperoxymaleic acid, bis(t-butylperoxy)isophthalate, methyl ethyl ketone peroxide, tert-butylperoxy-2-ethylhexanoate, diisopropyl peroxycarbonate, cumene hydroperoxide, 2,4-dichlorobenzoyl peroxide, and tert-butyl-peroxypivalate.

Examples of the azo-based polymerization initiators include 2,2′-azobis-(2,4-dimethylvaleronitrile), 2,2′-azobisisobutyronitrile, 1,1′-azobis(cyclohexane-1-carbonitrile), 2,2′-azobis-4 methoxy-2,4-dimethylvaleronitrile and azobismethylbutyronitrile, and 2,2′-azobis-(methyl isobutyrate).

In addition, a redox-based initiator that has an oxidizing substance and a reducing substance combined can also be used as a polymerization initiator.

Examples of the oxidizing substance include hydrogen peroxide, inorganic peroxides of persulfates (sodium salts, potassium salts, and ammonium salts), and oxidizing metal salts of tetravalent cerium salts.

Examples of the reducing substance include reducing metal salts (divalent iron salts, monovalent copper salts, and trivalent chromium salts), ammonia, lower amines (amines having from 1 to 6 carbon atoms, such as methylamine and ethylamine), amino compounds such as hydroxylamine, reducing sulfur compounds such as sodium thiosulfate, sodium hydrosulfite, sodium bisulfite, sodium sulfite, and sodium formaldehyde sulfoxylate, lower alcohols (carbon atoms from 1 to 6), ascorbic acid or salts thereof, and lower aldehyde (carbon atoms from 1 to 6).

The polymerization initiators are selected with reference to the 10-hour half-life temperature, and utilized alone or in mixture. The amount of the polymerization initiator added varies depending on the intended degree of polymerization, but typically, 0.5 parts to 20.0 parts of the polymerization initiator is added to 100.0 parts of the polymerizable monomer.

### Crystalline Material

As a crystalline material for improving the sharp melt property of the toner, a crystalline polyester resin can be used besides the crystalline resin having the monomer unit represented by the formula (1) and the ester wax.

The ester wax is not particularly limited, and known waxes for use in toners as follows can be used.

Esters from a monovalent alcohol and an aliphatic carboxylic acid, such as behenyl behenate, stearyl stearate, behenyl stearate, and palmityl palmitate, or esters from a monovalent carboxylic acid and an aliphatic alcohol; esters from a divalent alcohol and an aliphatic carboxylic acid, such as ethylene glycol distearate, dibehenyl sebacate, and hexanediol dibehenate, or esters from a divalent carboxylic acid and an aliphatic alcohol; esters from a trivalent alcohol and an aliphatic carboxylic acid, such as glycerin tribehenate, or esters from a trivalent carboxylic acid and an aliphatic alcohol; esters from a tetravalent alcohol and an aliphatic carboxylic acid, such as pentaerythritol tetrastearate and pentaerythritol tetrapalmitate, or esters from a tetravalent carboxylic acid and an aliphatic alcohol; esters from a hexaalcohol and an aliphatic carboxylic acid, such as dipentaerythritol hexastearate and dipentaerythritol hexapalmitate, or esters from a hexacarboxylic acid and an aliphatic alcohol; esters from a polyhydric alcohol and aliphatic carboxylic acid, such as polyglycerin behenate, or esters from a polyhydric carboxylic acid and an aliphatic alcohol; and natural ester waxes such as carnauba wax and rice wax. These waxes may be used alone or in combination. Among these waxes, ethylene glycol distearate, behenyl stearate, dipentaerythritol hexastearate are preferred.

As the crystalline polyester resin, for example, a condensation product from an aliphatic diol and an aliphatic dicarboxylic acid can be used.

### Crosslinking Agent

For controlling the molecular weight of the binder resin constituting the toner particle, a crosslinking agent may be added in the polymerization of the polymerizable monomer:

for example, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, neopentyl glycol diacrylate, divinylbenzene, bis(4-acryloxypolyethoxyphenyl)propane, ethylene glycol diacrylate, 1,3-butyleneglycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, respective diacrylates of polyethylene glycols #200, #400, and #600, dipropylene glycol diacrylate, polypropylene glycol diacrylate, polyester-type diacrylate (MANDA, Nippon Kayaku Co., Ltd.), and methacrylates obtained by changing the foregoing acrylates.

The amount of the crosslinking agent added is preferably from 0.001 parts by mass to 15.000 parts by mass with respect to 100 parts of the polymerizable monomer.

### Release Agent

For the toner, a known wax can be used as a release agent.

Specific examples thereof include petrolatum-based waxes such as a paraffin wax, a microcrystalline wax, and petroleum and derivatives thereof, montan waxes and derivatives thereof, hydrocarbon waxes obtained by a Fischer-Tropsch method and derivatives thereof, polyolefin waxes such as polyethylene and polypropylene and derivatives thereof, and natural waxes such as a carnauba wax and a candelilla wax and derivatives thereof. The derivatives include oxides, block copolymers with vinyl monomers, and graft-modified products.

In addition, the examples include alcohols such as higher aliphatic alcohols; fatty acids such as stearic acid and palmitic acid, or acid amides, esters, and ketones thereof; hydrogenated castor oils and derivatives thereof, plant waxes, and animal waxes. These waxes may be used alone or in combination.

In the case of using, among these waxes, the polyolefin, the hydrocarbon wax obtained by the Fischer-Tropsch method, or the petroleum-based wax, the developing performance and the transferability tend to be improved, which is preferred. Further, an antioxidant may be added to these waxes to the extent that the characteristics of the toner are not affected.

The content of the release agent is preferably from 1.0 parts by mass to 30.0 parts by mass with respect to 100.0 parts of the binder resin. In addition, the content of the release agent in the toner particle may be, for example, from 1% by mass to 30% by mass, or 2% by mass to 15% by mass.

The melting point of the release agent is preferably from 30° C. to 120° C., more preferably from 60° C. to 100° C. With the use of the release agent that has a melting point from 30° C. to 120° C., the release effect is efficiently exhibited, and a larger fixing region is secured.

### Colorant

The toner particle may contain a colorant. Known pigments and dyes can be used as the colorant. From the viewpoint of excellent weather resistance, pigments are preferred as the colorant.

Examples of cyan-based colorants include copper phthalocyanine compounds and derivatives thereof, anthraquinone compounds, and basic dye lake compounds.

Specific examples thereof include the following: C.I. Pigment Blue 1, 7, 15, 15:1, 15:2, 15:3, 15:4, 60, 62, and 66.

Examples of magenta-based colorants include condensed azo compounds, diketopyrrolopyrrole compound, anthraquinone compounds, quinacridone compounds, basic dye lake compounds, naphthol compounds, benzimidazolone compounds, thioindigo compounds, and perylene compounds.

Specific examples thereof include the following: C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254, and C.I. Pigment Violet 19.

Examples of yellow-based colorants include condensed azo compounds, isoindolinone compounds, anthraquinone compounds, azo metal complexes, methine compounds, and allylamide compounds.

Specific examples thereof include the following: C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of black colorants include colorants subjected to color matching to black with the use of the above-mentioned yellow-based colorants, magenta-based colorants, and cyan-based colorant, and carbon black.

These colorants can be used alone or in mixture, and used in the form of a solid solution.

The colorant is preferably used in an amount from 1.0 parts by mass to 20.0 parts by mass with respect to 100.0 parts of the binder resin.

### Charge Control Agent and Charge Control Resin

The toner particle may contain a charge control agent or a charge control resin. As the charge control agent, known charge control agents can be used, and in particular, a charge control agent that is high in triboelectric charging speed and capable of stably maintaining a constant triboelectric charge quantity is preferred. Furthermore, in the case of producing toner particles by a suspension polymerization method, a charge control agent is particularly preferred, which is low in polymerization inhibition performance and substantially free of solubilized products in the aqueous medium.

Examples of agents that control the toner to be negatively charged include monoazo metal compounds, acetylacetone metal compounds, aromatic oxycarboxylic acid, aromatic dicarboxylic acid, and oxycarboxylic and dicarboxylic acid-based metal compounds, aromatic oxycarboxylic acids, aromatic mono- and poly-carboxylic acids, and metal salts, anhydrides, and esters thereof, phenol derivatives such as bisphenol, urea derivatives, metal-containing salicylic acid-based compounds, metal-containing naphthoic acid-based compounds, boron compounds, quaternary ammonium salts, calixarenes, and charge control resins.

Examples of the charge control resin can include polymers or copolymers having a sulfonic acid group, a sulfonic acid base, or a sulfonic acid ester group. The polymer having a sulfonic acid group, a sulfonic acid base, or a sulfonic acid ester group is preferably, in particular, a polymer containing a sulfonic acid group-containing acrylamide-base monomer or a sulfonic acid group-containing methacrylamide-based monomer in a copolymerization ratio of 2% by mass or more, more preferably 5% by mass or more.

The charge control resin preferably has a glass transition temperature (Tg) from 35° C. to 90° C., a peak molecular weight (Mp) from 10,000 to 30,000, and a weight-average molecular weight (Mw) from 25,000 to 50,000. When this resin is used, preferred triboelectric charging characteristics can be imparted without affecting the thermal characteristics required for the toner particle. Furthermore, when the charge control resin contains a sulfonic acid group, for example, the dispersibility of the charge control resin itself in the polymerizable monomer composition and the dispersibility of the colorant or the like are improved, thereby allowing the tinting strength, the transparency, and the triboelectric charging characteristics to be further improved.

These charge control agents or charge control resins may be added alone or, two or more thereof may be added in combination.

The amount of the charge control agent or charge control resin added is preferably from 0.01 parts by mass to 20.0 parts by mass, more preferably from 0.5 parts by mass to 10.0 parts by mass or with respect to 100.0 parts of the binder resin.

### External Additive

The toner may include external additives. For example, for improving the flowability, charging performance, cleaning performance, and the like, a fluidizing agent, a charging aid, a cleaning aid, and the like may be added to the toner particle to obtain a toner.

Examples of the external additives include inorganic oxide fine particles such as silica fine particles and alumina fine particles, positively charged particles such as hydrotalcite and melamine resins, inorganic stearic acid compound fine particles such as aluminum stearate fine particles and zinc stearate fine particles. One of these external additives may be used alone, or two or more thereof may be used in combination.

The external additives preferably include inorganic oxide fine particles. The content of the external additive is, for example, 0.1 to 5.0 parts by mass, preferably 0.5 to 3.0 parts by mass with respect to 100 parts of the toner particle.

### Method for Producing Toner Particle

The toner particle preferably has a core particle containing a binder resin (for example, an amorphous resin) and a shell on the surface of the core particle. The method for producing the toner particle is not particularly limited, known means can be used, and kneading pulverization methods and wet production methods can be used. Examples of the wet production methods include a suspension polymerization method, a dissolution suspension method, an emulsion polymerization aggregation method, and an emulsion aggregation method. From the viewpoints of making the particle diameter uniform, shape controllability, and easiness of obtaining a toner particle that has a core-shell structure, the wet production methods are preferred, and among the methods, the suspension polymerization method and the emulsion aggregation method are preferred. The suspension polymerization method will be described below as an example.

### Suspension Polymerization Method

In the suspension polymerization method, first, a polymerizable monomer composition is prepared by uniformly dissolving or dispersing a polymerizable monomer for producing a binder resin, a colorant and, if necessary, other additives with the use of a disperser such as a ball mill, an ultrasonic disperser (step of preparing a polymerizable monomer composition). At this time, polyfunctional monomers, chain transfer agents, waxes as release agents, charge control agents, plasticizers, and the like can be appropriately added, if necessary.

Next, the polymerizable monomer composition mentioned above is put into an aqueous medium prepared in advance, and droplets made of the polymerizable monomer composition are formed into a desired size for a toner particle by a stirrer or a disperser with high shear force (granulating step).

The aqueous medium in the granulating step preferably contains a dispersion stabilizer, for controlling the particle diameter of the toner particle, sharpening the particle size distribution, and suppressing toner particle unification in the production process. Dispersion stabilizers, generally, are roughly classified into polymers that develop repulsive force due to steric hindrance and poorly water-soluble inorganic compounds that achieve dispersion stabilization with electrostatic repulsive force. Fine particles of the poorly water-soluble inorganic compounds are dissolved more in acids and alkalis, and can be thus dissolved and easily removed by washing with an acid or an alkali after polymerization, and thus, are suitably used.

Dispersion stabilizers containing any of magnesium, calcium, barium, zinc, aluminum, and phosphorus are preferably used as dispersion stabilizers of the poorly water-soluble inorganic compounds. More preferably, the dispersion stabilizers desirably contain any of magnesium, calcium, aluminum, phosphorus. Specific examples thereof include the following.

Magnesium phosphate, tricalcium phosphate, aluminum phosphate, zinc phosphate, magnesium carbonate, calcium carbonate, magnesium hydroxide, calcium hydroxide, aluminum hydroxide, calcium metasilicate, calcium sulfate, barium sulfate, hydroxyapatite.

The dispersion stabilizers may be used in combination with organic compounds, for example, a polyvinyl alcohol, gelatin, a methyl cellulose, a methyl hydroxypropyl cellulose, an ethyl cellulose, and a sodium salt of a carboxymethyl cellulose, starch. These dispersion stabilizers are preferably used in an amount from 0.01 parts by mass to 2.00 parts by mass with respect to 100 parts of the polymerizable monomer.

Furthermore, for micronization of these dispersion stabilizers, 100 parts of the polymerizable monomer may be used in combination with from 0.001 parts to 0.1 parts of a surfactant. Specifically, commercially available nonionic, anionic, and cationic surfactants can be used. For example, sodium dodecyl sulfate, sodium tetradecyl sulfate, sodium pentadecyl sulfate, sodium octyl sulfate, sodium oleate, sodium laurate, potassium stearate, and calcium oleate are preferably used.

After the granulating step or while performing the granulation step, the polymerizable monomer included in the polymerizable monomer composition is subjected to polymerization at a temperature preferably set from 50° C. to 90° C. to obtain a toner particle dispersion (polymerization step).

In the polymerization step, an stirring operation is preferably performed such that the temperature distribution in the container is uniform. In the case of adding the polymerization initiator, the polymerization can be performed at any timing and for a required time. In addition, the temperature may be raised in the latter half of the polymerization reaction for the purpose of obtaining a desired molecular weight distribution, and furthermore, for removing unreacted polymerizable monomers, by-products, and the like to the outside of the system, the aqueous medium may be partially distilled off by a distillation operation in the latter half of the reaction or after the completion of the reaction. The operation of distillation can be performed under normal pressure or reduced pressure.

As the polymerization initiator for use in the suspension polymerization method, an oil-soluble initiator is typically used. The polymerization initiator may be used in combination with a water-soluble initiator, if necessary.

These polymerization initiators can be used alone or in combination, and for controlling the degree of polymerization of the polymerizable monomer, it is also possible to further add and use chain transfer agents, polymerization inhibitors, and the like.

After the polymerization step, it is preferable to carry out a cooling step of cooling the temperature of the obtained toner particle dispersion by controlling the cooling rate to a temperature that is lower than the crystallization temperature or glass transition temperature of the binder resin. Examples of the cooling rate, for example, 1 to 300° C./sec, preferably 2 to 200° C./sec, and more preferably 5 to 100° C./sec. The cooling step solidifies the binder resin before the crystal growth of the crystalline material, thereby allowing crystal nuclei of the crystalline material to be dispersed in the binder resin.

In addition, an annealing step may be carried out after the cooling. The annealing temperature is preferably 45° C. to 65° C. In addition, the annealing time is preferably 1 to 15 hours, or 2 to 12 hours. The annealing step allows crystal growth of the compatible crystalline material in the binder resin with the crystal nuclei as starting points.

The toner particle diameter is preferably from 3.0 μm to 10.0 μm in weight-average particle diameter from the viewpoint of obtaining high-definition and high-resolution images. The volume-average particle diameter of the toner can be measured by a pore electrical resistance method. The volume-average particle diameter can be measured with the use of “Coulter Counter Multisizer 3” (manufactured by Beckman Coulter, Inc.). The thus obtained toner particle dispersion is fed to a filtration step of solid-liquid separation between the toner particle and the aqueous medium.

The solid-liquid separation for obtaining the toner particle from the obtained toner particle dispersion can be performed by a common filtration method, and thereafter, for removing foreign matters incompletely removed from the toner particle surface, further washing is preferably performed by reslurry, washing with washing water, or the like. After sufficient washing is performed, the solid-liquid separation is performed again to obtain a toner cake. Thereafter, the toner cake is dried with a known drying means, and if necessary, a particle group with particle diameters outside a predetermined range is separated by classification to obtain a toner particle. The thus separated particle group with particle diameters outside the predetermined range may be reused for improving the final yield.

### Method for Producing Toner

The mixer for externally adding an external additive to the toner particle is not particularly limited, and known mixers can be used regardless of dry of wet type. Examples thereof include an FM mixer (manufactured by NIPPON COKE & ENGINEERING CO., LTD.), SUPERMIXER (manufactured by Kawata M. Co., Ltd.), NOBILTA (manufactured by HOSOKAWA MICRON CORPORATION), and a hybridizer (manufactured by NARA MACHINERY CO., LTD.). For controlling the state of covering with the external additive, the toner can be prepared while adjusting the number of rotations of the external addition apparatus mentioned above, the treatment time, and the water temperature and water amount of the jacket.

In addition, examples of a sieving apparatus that is used for sieving coarse particles after the external addition include ULTRASONIC (manufactured by KOEI SANGYO CO., LTD.); Resona Sieve and Gyro-Sifter (TOKUJU CORPORATION); a Vibrasonic system (manufactured by DALTON CORPORATION); Soniclean (manufactured by SINTOKOGIO, LTD.); TURBO-SCREENER (manufactured by Turbo Kogyo Co., Ltd.); and a micro shifter (manufactured by MAKINO Mfg. Co., Ltd.).

### Developing Roller

The developing roller according to at least one aspect of the present disclosure includes a conductive substrate and a resin layer on the outer peripheral surface of the substrate.

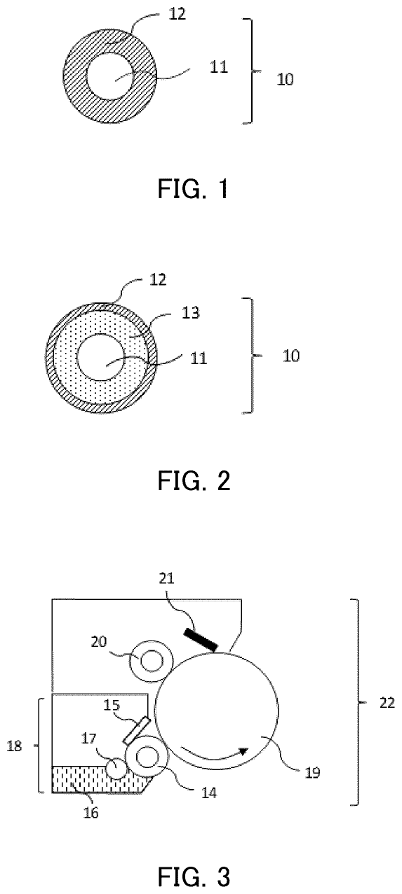

An example of the developing roller is illustrated in FIG. 1. In the developing roller 10 illustrated in FIG. 1, a resin layer 12 is laminated on the outer peripheral surface of a columnar or hollow cylindrical substrate 11.

It is to be noted that the configuration of the layer of the developing roller is not limited to the configuration illustrated in FIG. 1. As another embodiment of the developing roller, as illustrated in FIG. 2, an elastic layer 13 may be provided between the substrate 11 and the resin layer 12 provided on the outer peripheral surface of the substrate 11.

In the case of charging the outer surface of the developing roller with a corona discharger and measuring the potential of the outer surface after 0.06 seconds from the end of the charging, the maximum value of the potential is preferably less than 20.0 V. The surface potential of the electrophotographic roller indicates the residual charge on the surface of the electrophotographic roller. When the potential is less than 20.0 V, the toner can be appropriately charged, which is preferred from the viewpoint of image fogging, and the toner can be kept from sticking to the developing roller, which is preferred from the viewpoint of reducing a decrease in image density. The maximum value of the potential is preferably 15.0 V or less, more preferably 10.0 V or less. The potential of the outer surface preferably has a smaller maximum value, and the lower limit is not particularly limited.

The maximum value of the potential of the outer surface a preferred range of, for example, 0 V or more and less than 20.0 V, particularly from 0 V to 15.0 V, still more preferably from 0 V to 10.0 V.

As the impedance characteristics of the developing roller, the developing roller preferably has one elementary process obtained from the AC impedance measurement from 1.0×10⁴ Hz to 1.0×10⁶ Hz. The number of elementary processes is one, thereby allowing the charge-up of the developing roller to be further suppressed.

In order to control the physical property mentioned above, examples of the control include a means for improving the dispersibility of the conductive fine particles with the use of the material of the resin layer, the material of the conductive fine particles, and additives as follows.

Specific examples thereof include, for one elementary process, methods such as using a conductive material that has a close conductive property in combination, and employing one means for conductivity such as ionic conductivity or electronic conductivity.

### Substrate

The substrate has an electrically conductive outer surface and functions as a support member for the developing roller and, in some cases, as an electrode. A specific example of the substrate preferably has a solid cylindrical or hollow cylindrical shape.

The material constituting the substrate can be appropriately selected from materials known in the field of conductive member for electrophotography and materials that are available as such a developing roller, and then used. Example thereof include a metal represented by aluminum and stainless steel, a carbon steel alloy, a conductive synthetic resin, a metal or an alloy such as an iron or a copper alloy.

Furthermore, the material constituting the substrate may be subjected to oxidation treatment or plating treatment with chromium, nickel, or the like. As the type of plating, both electroplating and electroless plating can be used. From the viewpoint of dimensional stability, electroless plating is preferred. Examples of the type of electroless plating for use herein can include nickel plating, copper plating, gold plating, and other various kinds of alloy plating. The plating thickness is preferably 0.05 μm or more, and the plating thickness is preferably 0.1 to 30 μm in consideration of the balance between working efficiency and antirust ability.

For improving the adhesion between the substrate and the resin layer, a primer may be applied to the surface of the substrate. As the primer, known primers can be selected and then used depending on the rubber material for resin layer formation, the material of the support, and the like. Examples of materials for the primer include thermosetting resins and thermoplastic resins, and specifically, materials such as a phenolic resin, polyurethane, an acrylic resin, a polyester resin, a polyether resin, and an epoxy resin can be used.

### Resin Layer

The developing roller has the resin layer on the outer surface of the substrate. For example, the resin layer is present on the outer surface of the developing roller. The resin layer may have a binder resin. As the binder resin of the resin layer in the developing roller, a polyurethane is preferably used for suppressing charge leakage from the toner to the developing roller. The polyurethane preferably has at least one selected from the group consisting of a polyether structure and a polycarbonate structure, more preferably has a polycarbonate structure. More specifically, the resin layer preferably includes a polyurethane, more preferably includes a polyurethane that has a polycarbonate structure. Having the polycarbonate structure allows the surface strength to be increased, and allows the electrical resistance to be improved, and thus, easily maintains characteristics as a developing roller through a durability test.

The structure of the polymer included in the surface layer of the developing roller can be checked by, for example, thermal decomposition GC/MS, FT-IR, or NMR analysis.

The polyurethane can be produced with the use of a (A) polyol compound and a (B) polyisocyanate compound. Typically, the synthesis of the polyurethane can employ the following methods (1) and (2):
(1) a one-shot process of mixing and reacting a polyol component and a polyisocyanate component; and
(2) a process of reacting a part of polyol with an isocyanate to yield an isocyanato group-terminated pre-polymer and then reacting the isocyanato group-terminated prepolymer with a chain extender such as a low molecular diol or a low molecular triol.

In the present disclosure, the polyurethane may be synthesized by any of the methods mentioned above, but more preferred is a method of developing a heat curing reaction between a hydroxyl group-terminated prepolymer obtained by reacting a raw material polyol with an isocyanate and an isocyanate group-terminated prepolymer obtained by reacting a raw material polyol with an isocyanate.

The polyurethane is preferably a reaction product of a mixture including a hydroxyl group-terminated prepolymer and an isocyanato group-terminated prepolymer. The mixture can be used as a coating liquid for resin layer formation. The polyurethane is more preferably a reaction product of a mixture including a hydroxyl group-terminated prepolymer, an isocyanato group-terminated prepolymer, and an additive.

In the case of including many hydroxyl groups or isocyanato groups, or urea bonds, allophanate bonds, isocyanurate bonds, or the like, many polar functional groups are present in the polyurethane, and thus, the water absorbability of the polymer may be increased, thereby decreasing the volume resistivity of the resin layer. In contrast, heat-curing the hydroxyl group-terminated prepolymer and the isocyanato group-terminated prepolymer allows a polyurethane with less unreacted polyol and fewer polar functional groups to be obtained without using any excess isocyanate. For this reason, the polyurethane is preferred from the viewpoint of further suppressing charge leakage from the toner to the developing roller.

### (A) Polyol Compound

As the polyol compound, polyols that are known for urethane resin synthesis or can be used for urethane resin synthesis can be used. Examples of the polyol compound include the following: polyolefin polyols such as polycarbonate polyols, polyether polyols, polyester polyols, polybutadiene polyols, and polyisoprene polyols, so-called polymer polyols obtained by polymerizing ethylenically unsaturated monomers in polyols, and polyester polycarbonate copolymer polyols.

The polyol compound is, among there polyols, preferably at least one selected from the group consisting of the polycarbonate polyols and the polyester polycarbonate copolymer polyols.

Examples of the polycarbonate polyols may include the following: polynonamethylene carbonate diol, poly(2-methyl-octamethylene) carbonate diol, polyhexamethylene carbonate diol, polypentamethylene carbonate diol, poly(3-methylpentamethylene) carbonate diol, polytetramethylene carbonate diol, polytrimethylene carbonate diol, poly(1,4-cyclohexanedimethylene carbonate) diol, poly(2-ethyl-2-butyl-trimethylene) carbonate diol, and random or block copolymers thereof.

Examples of the polyester polycarbonate copolymer polyols include the following: copolymers obtained by polycondensation of the polycarbonate polyols with lactones such as F-caprolactone; and copolymers of diols such as 1,4-butanediol, 1,5-pentanediol, 1,6-hexanediol, 3-methylpentanediol, and a neopentyl glycol and polyesters obtained by polycondensation of dicarboxylic acids such as an adipic acid and a sebacic acid.

### (B) Polyisocyanate Compound

The polyisocyanate is selected from commonly used known polyisocyanates, and examples thereof may include the followings: toluene diisocyanate (TDI), diphenylmethane diisocyanate (MDI), polymeric diphenylmethane polyisocyanate, hydrogenated MDI, polymeric MDI, xylylene diisocyanate (XDI), hexamethylene diisocyanate (HDI), and isophorone diisocyanate (IPDI). Among these polyisocyanates, the aromatic isocyanates such as toluene diisocyanate (TDI), diphenylmethane diisocyanate (MDI), polymeric diphenylmethane polyisocyanate, and polymeric MDI are more suitably used. Other polyisocyanates can be also used as long as the impedance value and the surface potential are not affected.

The ratio of the number of isocyanato groups to the number of hydroxyl groups (hereinafter, referred to also as “NCO/OH ratio”) is preferably 1.0 to 2.0. If the ratio of NCO/OH is 1.0 to 2.0, the crosslinking reaction proceeds, and the oozing, so-called “bleeding” of unreacted components and low molecular weight polyurethane is suppressed. The ratio of NCO/OH is more preferably 1.0 to 1.6. If the ratio of NCO/OH is 1.0 to 1.6, bleeding is suppressed, and the hardness of the polymer can be suppressed.

The content ratio of the polyurethane in the resin layer is not particularly limited, but preferably 50% to 95% by mass, more preferably 60% to 80% by mass, still more preferably 65% to 75% by mass.

### Conductive Filler

The resin layer preferably contains a conductive filler to obtain conductivity. It is more preferable to use an electronic conducting agent as the conductive filler in the resin layer. Conductive particles that exhibit electronic conductivity, as the electronic conducting agent, preferably have a surface functional group capable of interacting with a functional group present in an additive described later.

Examples of electronic conducting agent that exhibits these properties include at least one selected from the group consisting of carbon blacks such as furnace black, thermal black, acetylene black, and Ketjen black, metal oxide-based conductive particles such as a titanium oxide that has a surface treated with an acidic functional group, and metal-based conductive particles such as aluminum or iron that has surface treated with an acidic functional group.

The resin layer preferably contains conductive fine particles as the conductive filler.

As the conductive fine particles, at least one selected from the group consisting of carbon blacks, indium-tin-based oxides, and antimony-titanium-based oxides is suitably used. The conductive fine particles more preferably include a carbon black. Furthermore, the number average diameter of primary particles, which allows higher dispersion to be achieved in the resin layer, is 30 nm or less for obtaining desired impedance values and surface potentials. As for carbon blacks that are likely to form a structure, carbon blacks that have a DBP absorption amount of 90 ml/100 g or less and a pH of 4.0 or less are particularly suitably used.

When the number average diameter of the primary particles of the conductive fine particles is 30 nm or less, a conductive path is less likely to be formed by a series of conductive fine particles, thus making a sufficiently high impedance Z likely to be obtained. The primary particle diameter of the conductive fine particles can be calculated with a transmission electron microscope (TEM). The number average diameter is preferably lower, and the lower limit is not particularly limited. For example, the number average diameter of the primary particles of the conductive fine particles is, for example, 5 to 55 nm, preferably 5 to 30 nm, more preferably 20 to 28 nm.

However, even if the number average diameter, DBP absorption amount, and pH of the primary particles of the carbon black fall within the ranges mentioned above, the use of a polycarbonate urethane as a binder resin may cause the carbon black to be dispersed insufficiently, and fail to obtain a desired impedance in some cases. The reason why the carbon black with desired raw material properties fails to be dispersed when a polycarbonate urethane is used as a binder resin is not clearly known, but is presumed as follows.

The hydroxyl group, which is a surface functional group of the carbon black, is likely to interact with the hydroxyl group at the terminal of the polycarbonate diol. In contrast, the structure that has a carbonate bond and a hydrocarbon group bonded, which is present between two hydroxyl groups of the polycarbonate diol, is hydrophobic due to the presence of the hydrocarbon group, and is less likely to interact with the carbon black. The structure is more stable when hydrophobicity is present near hydrophobicity or when hydrophilicity is present near hydrophilicity, and thus, the same hydrophilic carbon black is present in the vicinity of the hydrophilic carbon black. As a result, the carbon black is considered likely to aggregate, and less likely to disperse.

In order to sufficiently disperse the carbon black with the number average diameter, DBP absorption amount, and pH of the primary particles in the numerical ranges mentioned above with the use of a polycarbonate urethane as a binder resin, it is more preferable to add additives described below.

In designing the developing roller to have a desired impedance Z, the resistance of the conductive fine particles is preferably from 1 Ω·m to 1000 Ω·m, more preferably from 1 Ω·m to 10 Ω·m.

The content of the conductive fine particles is preferably 30 parts by mass or less with respect to 100 parts of the polyurethane that forms the resin layer, although it is desirable to add the conductive fine particles so as to achieve a desired impedance Z. The content is more preferably 10 to 30 parts by mass, still more preferably 15 to 25 parts by mass.

When the content is 30 parts by mass or less, the distance between the conductive fine particles in the coating liquid is kept moderate, thereby reducing the collision probability of the conductive fine particles due to Brownian motion or the like, and making the conductive fine particles less likely to aggregate. Thus, the conductive fine particles are more likely to disperse, and the dispersion stability is also improved. As a result, the dispersion of the conductive fine particles is improved in the resin layer into which the coating liquid is formed.

In order to achieve the specific impedance and surface potential mentioned above, it is preferable to control the dispersion of the conductive fine particles. As the dispersed particle diameter of the conductive fine particles, the circle-equivalent diameters of the conductive fine particles in the resin layer preferably has an arithmetic mean Rc of 60 nm or less. Further, when the standard deviation of the circle-equivalent diameters is referred to as σc [nm], σc/Rc is more preferably 0.00 to 0.65.

In addition, as the distance between the conductive fine particles, the wall-to-wall distances of the conductive fine particles in the resin layer have an arithmetic mean d, for example, 60 to 150 nm, preferably 80 to 150 nm. In addition, when the standard deviation of the wall-to-wall distances is referred to as σd [nm], σd/d is, for example, 0.00 to 0.65, more preferably 0.00 to 0.60.

The reason why the high impedance and the low surface potential are more easily compatible when the circle-equivalent diameter and the wall-to-wall distance fall within the numerical ranges mentioned above is presumed as follows.

When the dispersed particle diameters are larger, there are sites where the wall-to-wall distance is shorter, a conductive path is likely to be formed, and thus, the impedance Z and the surface potential are both decreased. In contrast, when the dispersed particle diameter is reduced, the wall-to-wall distance is more uniform, and a conductive path is less likely to be formed, thereby increasing the resistance, and then increasing the impedance Z. As for the surface potential, the local accumulation of electric charge is less likely to be caused, thus allowing the surface potential to be lowered.

It is to be noted that multiple types of conductive fine particles may be used in combination to the extent that the impedance Z and the surface potential are not affected.

The arithmetic mean Rc of the circle-equivalent diameters is, for example, 40 to 102 nm, preferably 40 to 60 nm, more preferably 50 to 60 nm. σc/Rc is, for example, 0.50 to 0.80, preferably 0.50 to 0.65, more preferably 0.55 to 0.65.

The arithmetic mean Rc and standard deviation σc of the circle-equivalent diameters can be changed depending on the dispersion state in a mill or the like in preparing the coating liquid for resin layer formation, for example. Rc and σc tend to be increased when the dispersion is weakened, whereas Rc and σc tend to be decreased when the dispersion is strengthened. Typically, Rc converges, and thus, beyond a certain dispersion state, σc can be lowered with Rc kept substantially constant, thereby reducing σc/Rc.

The arithmetic mean d of the wall-to-wall distances is more preferably 90 to 120 nm, still more preferably 95 to 115 nm. σd/d is more preferably 0.50 to 0.60, still more preferably 0.54 to 0.59.

The arithmetic mean d and standard deviation σd of the wall-to-wall distances can be changed depending on the dispersion state in a mill or the like in preparing the coating liquid for resin layer formation, for example. d and σd tend to be respectively decreased and increased when the dispersion is weakened, whereas d and σd tend to be respectively increased and decreased when the dispersion is strengthened. Thus, σd/d tends to be increased when dispersion is weaker, whereas σd/d tends to be decreased when dispersion is stronger.

### Additives

It is also one of preferred aspects to use an additive for further improving the dispersibility of the carbon black into the binder resin in which a polycarbonate urethane is used. In this regard, for example, at least one compound selected from the group consisting of a compound that has a structure represented by the following formula (2), a compound that has a structure represented by the following formula (3), and a compound that has a structure represented by the following formula (4) can be suitably used as the additive. One of methods for containing the additive in the surface layer is a method of containing a dispersing agent in a coating liquid for surface layer formation. In the surface layer formed with the use of a coating liquid for surface layer formation, containing at least one compound selected from the group consisting of a compound that has a structure represented by the formula (2) and a compound that has a structure represented by the formula (3), the compound can be incorporated at the terminal of the polymer chain of the polyurethane in some cases. Even in such a case, the effect of improving the dispersibility of the carbon black can be expected, but it is preferable to be present in the surface layer independently of the polyurethane.

Among the compounds that have the structures represented by the formulas (2) to (4), the compound that has the structure represented by the formula (2) is more suitably used because the dispersibility of the carbon black and the affinity with the polycarbonate urethane are particularly excellent.

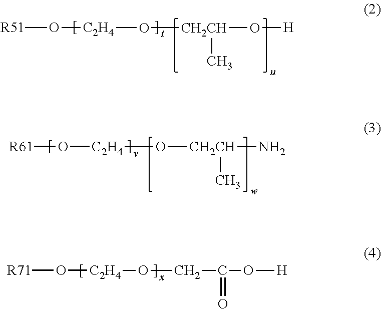

In the structural formula (2), R51 represents a monovalent hydrocarbon group having 1 to 12 (preferably 3 to 12) carbon atoms. t and u are average numbers of moles added, and each independently represent a number of 1 or more (preferably 5 to 30, more preferably 10 to 25).

In the structural formula (3), R61 represents a monovalent hydrocarbon group having 1 to 8 (preferably 1 to 4) carbon atoms. v and w are average numbers of moles added, and each independently represent a number of 1 or more (preferably 1 to 30, more preferably 5 to 30).

In the structural formula (4), R71 represents a monovalent hydrocarbon group having 1 to 12 carbon atoms. x is an average number of moles added, and represents a number of 1 or more (preferably 1 to 30, more preferably 4 to 15).

The formula (2) is a polyoxyethylene polyoxypropylene alkyl ether, and is a polyether monool that has a structure obtained by addition polymerization of an ethylene oxide and a propylene oxide in a block form. The hydroxyl group at the terminal of the polyether monool interacts with the surface functional group of the carbon black, which is a conductive filler, by hydrogen bonding, and acts as a dispersing agent for the carbon black. In addition, for enhancing the effect of the carbon black as a dispersing agent, the structure is also compatible with the polycarbonate urethane.

The ethylene oxide is introduced into the structure to make the additive uniformly present in the polycarbonate urethane. This is believed to be because ethylene groups in the ethylene oxide are compatible with hydrophobic hydrocarbon groups in polycarbonate urethane. In addition, the propylene oxide is introduced into the structure to improve the dispersibility of the conductive filler dispersed in the resin layer. This is believed to be because side chain methyl groups of the propylene oxide interact with the conductive filler to improve the dispersibility of the conductive filler.

R51, which is a monovalent hydrocarbon group having 1 to 12 carbon atoms, is introduced into the structure for causing the additive to be present uniformly in the polycarbonate urethane. The monovalent hydrocarbon group makes the additive compatible with the hydrophobic hydrocarbon groups in the polycarbonate urethane, and the additive can be present uniformly in the polycarbonate urethane. When the number of carbon atoms is 12 or less, steric hindrance with the polycarbonate urethane is less likely to be caused, and the additive is likely to be present uniformly.

Further, the compound of the formula (2) has a monool structure, thus has poorer reactivity than diols, and is less likely to be incorporated in the urethanization reaction between the isocyanate and the polyol, and the introduction of an ether structure into the polycarbonate urethane is less likely to cause a decrease in the resistance of the polyurethane.

The polyoxyethylene polyoxypropylene alkyl ether can be obtained by using a commercial product or by synthesis. The polyoxyethylene polyoxypropylene alkyl ether can be synthesized by carrying out a step (B) after the following step (A). It is to be noted that a commercial product that has a structure obtained by completing the step (A) may be subjected to the step (B).

Step (A): a reaction of an alcohol with an ethylene oxide

Step (B): a reaction of the product obtained in the step (A) with a propylene oxide

In the step (A), the reaction is allowed to proceed by adding an ethylene oxide to an alcohol at 50° C. to 200° C., more preferably 100° C. to 160° C., in the presence of a catalyst. The ethylene oxide has a boiling point of 10.7° C., and is a gas at the temperatures mentioned above, and thus, is preferably reacted in an environment pressurized in a sealed container. The pressure is preferably 0.1 MPa to 1.0 MPa. The reaction time is not particularly limited, but is preferably approximately 1 hour to 3 hours to reduce the unreacted ethylene oxide.

As the catalyst, an acid catalyst or an alkali catalyst can be used, but an alkali catalyst is preferred in order to facilitate purification after the completion of the reaction. Examples of the alkali catalyst include hydroxides of alkali metals, such as a sodium hydroxide and a potassium hydroxide, hydroxides of alkaline earth metals, such as a calcium hydroxide and a barium hydroxide, ammonium hydroxides, and tertiary amines. In view of ease of reaction and reaction efficiency, a sodium hydroxide and a potassium hydroxide are particularly preferred. Examples of the acid catalyst include Broensted acids such as a sulfuric acid and a phosphoric acid, and Lewis acids such as a stannic chloride and a boron trifluoride.

The amount of the catalyst used is, in the case of a sodium hydroxide and a potassium hydroxide, preferably 0.1 to 5 mol % with respect to 1 mol of the alcohol. The ethylene oxide reacts with water to produce an ethylene glycol, thus, moisture is avoided as much as possible, and if necessary, dehydration treatment may be performed prior to the reaction in the step (A).

The step (B) can be carried out under the same conditions as in the step (A). The propylene oxide has a boiling point of 34.2° C., and is a gas at the reaction temperature of 50° C. to 200° C., and thus, is preferably reacted in an environment pressurized in a sealed container. The catalyst used in the step (A) may be used as such, or may be added newly. In the case of newly adding the catalyst, the catalyst used in the step (A) is preferred.

The formula (3) is a polyetheramine (monoamine) that has a structure obtained by addition polymerization of an ethylene oxide and a propylene oxide in a block form. The amino group at the terminal of the polyether amine interacts with the surface functional group of the carbon black, which is a conductive filler, by hydrogen bonding, and acts as a dispersing agent for the carbon black. In addition, for enhancing the effect as a dispersing agent, R61, which is a monovalent hydrocarbon group having 1 to 8 carbon atoms, is introduced, thereby providing a structure that is likely to have affinity with the hydrophobic functional group of the polycarbonate urethane, and is also compatible with the polycarbonate urethane.

The polyetheramine can be obtained by using a commercial product or by synthesis. The polyetheramine can be synthesized by carrying out a step (D) after the following step (C).

Step (C): an oxidation reaction of the compound of the formula (2), which is a secondary alcohol

Step (D): a reductive amination reaction of the product obtained in the step (C)

The step (C) is a reaction of producing a ketone in an oxidation reaction of a secondary alcohol. The ketone synthesis by the oxidation of a secondary alcohol includes: an oxidation reaction with the use of a heavy metal salt such as a chromic acid or a manganese dioxide and a derivative thereof; and an oxidation reaction of a non-heavy metal salt with the use of a dimethyl sulfoxide (DMSO) or a hypohalous acid such as a hypochlorous acid.

The synthesis may be performed by using any of the methods, but the oxidation reaction with the use of a dimethyl sulfoxide (DMSO) or a hypohalous acid such as a hypochlorous acid is preferred in view of environmental influence by heavy metals. Furthermore, the method of using a hypohalous acid is more preferred because the reaction of a dimethyl sulfoxide (DMSO) explosively proceeds at room temperature depending on the electrophilic activation reagent to be used, and thus requires a low temperature of −60° C. Examples of the hypohalous acid include hypochlorites such as a sodium hypochlorite and a calcium hypochlorite (bleaching powder). These hypochlorite salts are reacted with a secondary alcohol in acetic acid to obtain a ketone.

In the case of using a dimethyl sulfoxide (DMSO), an electrophilic activation reagent is required additionally. Increasing the electrophilicity of sulfur of the dimethyl sulfoxide (DMSO) with the electrophilic activating reagent causes the alcohol hydroxyl group to undergo nucleophilic attack. This nucleophilic attack produces a dimethyl alkoxy sulfonium salt, and this dimethyl alkoxy sulfonium salt is decomposed to obtain a ketone and a dimethyl sulfide. Examples of the electrophilic activation reagent include dicyclohexylcarbodiimide (DCC), an acetic anhydride, a phosphorus pentoxide, a sulfur trisulfide-pyridine complex, a trifluoroacetic anhydride, an oxalyl chloride, and halogen.

The step (D) is a reductive amination reaction of converting a ketone to an amine. The reaction is divided into two stages. First, the carbonyl group reacts with the amine to produce an iminium cation. Subsequently, a hydride reducing agent nucleophilically attacks the iminium cation to produce an amine. As the reducing agent, a borohydride reagent is preferably used. Examples of the borohydride reagent include a sodium cyanoborohydride, a sodium triacetoxyborohydride, and 2-picoline-borane, and among these reagents, the sodium triacetoxyborohydride and the 2-picoline-borane, which are less toxic, are preferred. The reductive amination reaction with the borohydride reagent is, in the case of a bulky structure, less likely to produce the iminium cation due to steric hindrance. Thus, R61 in the structural formula (3) is preferably a monovalent hydrocarbon group having 1 to 8 carbon atoms.

The formula (4) is a polyoxyethylene alkyl ether acetate. The terminal carboxylic acid in the formula (4) interacts with the surface functional group of the carbon black, which is a conductive filler, by hydrogen bonding, and acts as a dispersing agent for the carbon black. In addition, for enhancing the effect as a dispersing agent, R71, which is a monovalent hydrocarbon group having 1 to 12 carbon atoms, is introduced, thereby providing a structure that is likely to have affinity with the hydrophobic functional group of the polycarbonate urethane, and is also compatible with the polycarbonate urethane.

The polyoxyethylene alkyl ether acetate can be obtained by using a commercial product or by synthesis. The polyoxyethylene alkyl ether acetate can be synthesized by carrying out a step (F) after the following step (E). It is to be noted that a commercial product that has a structure obtained by completing the step (E) may be subjected to the step (F).

Step (E): a reaction of an alcohol with an ethylene oxide

Step (F): an oxidation reaction of a primary alcohol, which is a product in the step (E)

The step (E) is the same as the step (A), and can be prepared by the same method as the step (A).

The step (F) is a step of oxidizing a primary alcohol to produce a carboxylic acid. In the oxidation of the primary alcohol, a carboxylic acid is produced by further oxidation after producing an aldehyde, and thus it is necessary to select reaction methods and conditions that are not stopped by the aldehyde. Examples of the method for obtaining a carboxylic acid through oxidation of a primary alcohol include reactions of oxidation with an oxidizing agent and catalytic dehydrogenation with a catalyst. Examples of the oxidizing agent may include a permanganate, a chromic acid, a ruthenium tetroxide, and a hypochlorite. Examples of the catalyst for the dehydrogenation reaction may include palladium, platinum, iridium, rhodium, and manganese.

The compounds represented by the formulas (2) to (4) are compounds that have a function as a dispersing agent for the conductive fine particles, and have high affinity with the polycarbonate urethane. Typically, a surfactant is used as a method for improving the dispersibility and dispersion stability of the conductive fine particles. However, the compounds represented by the formulas (2) to (4) are not commonly used because of the small number of functional groups that act on the surface functional groups of the conductive fine particles, and thus the weak surface-active action. Coupling agents and nonionic surfactants are utilized as common dispersing agents for fine particles.

As the coupling agents, silane coupling agents, titanate-based coupling agents, and aluminum-based coupling agents are used, and as the nonionic surfactants, polyester-based and polyether-based surfactants are used. However, when these dispersing agents are added in the polycarbonate urethan to a level at which the dispersibility of the carbon black is sufficiently enhanced (ratio by mass from 50% to 100%, with respect to the carbon black), the conductivity of the carbon black and binder resin is inhibited. Conversely, with the amounts of the dispersing agents added at a level at which the conductivity of the carbon black and binder resin is not inhibited (ratio by mass from 10% to 40%, with respect to the carbon black), the dispersibility of the carbon black fails to be obtained.

The amount of the added compounds represented by formulas (2) to (4) is preferably 3.0% by mass to 7.0% by mass based on the solid content in the coating for surface layer formation. More preferably, the content is 3.0% by mass to 5.0% by mass. In addition, the total content is preferably 18.9 to 46.0 parts by mass with respect to 100 parts of the carbon black in the coating for surface layer formation.

When the content of the additives in the coating for surface layer formation falls within the range mentioned above, the dispersibility of the conductive fine particles into the polyurethane is further improved, and desired impedance values and surface potentials can be easily achieved.

The presence confirmation and quantitative evaluation of additives in the resin layer can be analyzed by the following method. The resin layer of the developing roller is cut out, and the slice is analyzed with the use of, for example, ¹H-NMR, ¹³C-NMR, XPS, and FT-IR. Thus, the carbonate structure of the binder resin, and the ether structure, amine structure, and carboxylic acid structure of the additive can be detected in the resin layer, and the ratios can be calculated from the proportions of peaks and the like.

In addition, the slice is immersed overnight in an organic solvent such as 2-butanone (methyl ethyl ketone; MEK) and then extracted, and the extract liquid and the extracted slice are analyzed with the use of ¹H-NMR, ¹³C-NMR, XPS, and FT-IR. Thus, the proportions of the additive incorporated in the polymerization reaction of the resin and of the additive that is not incorporated therein can be calculated.

### Course Particle

The resin layer may contain a coarse particle. The coarse particle may be, for example, a spherical particle. The particle diameter of the coarse particles falls, for example, preferably within the range of 1 μm to 150 μm, more preferably within the range of 5 μm to 30 μm. Examples thereof include at least one spherical particle selected from the following particles:

urethane resin particles, acrylic resin particles, phenol resin particles, silicone resin particles, polyacrylonitrile resin particles, polystyrene resin particles, polyurethane resin particles, nylon resin particles, polyethylene resin particles, and polypropylene resin particles. Preferably, the particle is an urethane resin particle.

The content ratio of the coarse particle is preferably 1% by mass to 20% by mass, more preferably 5% by mass to 15% by mass in the resin layer.

The developing roller may have an elastic layer on the outer surface of the substrate. The developing roller has, for example, an elastic layer between the substrate and the resin layer. The elastic layer is not particularly limited, and a known elastic layer may be used as the elastic layer of the developing roller. Examples thereof include a cured product of an addition curing-type liquid silicone rubber mixture.

### Production Method

The method for forming the resin layer is not particularly limited, and examples thereof may include methods by spraying, dip coating, or roll coating with a coating material. For example, a coating liquid for resin layer formation can be applied by a known method onto the elastic layer formed on the substrate or the outer surface of the substrate, and heated and dried to form a resin layer. The condition for heating and drying is not particularly limited, and examples thereof include a method of drying under a condition at 120° C. to 200° C. The thickness of the resin layer is also not particularly limited, and is preferably 1 to 50 μm, more preferably 5 to 20 μm.

### Process Cartridge and Electrophotographic Image Forming Apparatus

The developing roller according to the present disclosure can be suitably used as a developing roller in a process cartridge. The process cartridge includes the developing apparatus according to the present disclosure. FIG. 3 is a schematic sectional view of an example of a process cartridge according to an aspect of the present disclosure. A process cartridge 22 is configured to be attachable and detachable to a main body of an electrophotographic image forming apparatus. The process cartridge 22 includes; a developing apparatus 18 including a developing roller 14 and a developing blade 15; a photosensitive member 19; a charging roller 20; and a cleaning blade 21, which are integrated together. The developing apparatus 18 is further filled with a toner 16. The toner 16 is supplied by a toner supply roller 17 to the surface of the developing roller 14, and a layer of the toner 16 with a predetermined thickness is formed by the developing blade 15 on the surface of the developing roller 14.

The developing roller 14 is rotationally driven in contact with the photosensitive member 19 and at a predetermined peripheral speed ratio with respect to the photosensitive member 19. In addition, a predetermined bias is applied to the developing roller 14 to develop and visualize an electrostatic latent image on the photosensitive member 19 with the use of the toner 16.

The toner supply roller 17 comes into contact with the developing roller 14, penetrates at a predetermined penetration level, and rotates in the same direction as or reverse direction to the rotational direction of the developing roller 14. In addition, a predetermined bias is applied to the toner supply roller 17.

One end of the developing blade 15 is fixed to the developing apparatus 18, and the other free end thereof is disposed in contact with the developing roller 14 in a counter direction with respect to the rotational direction of the developing roller 14. Disposing the developing blade 15 in contact with the developing roller 14 regulates the amount of the toner on the developing roller 14 for a thinner layer to form a toner layer with a uniform thickness. In addition, a predetermined bias is applied to the developing blade 15 to charge the toner 16.

The developing apparatus has the developing roller 14 and the toner 16. In addition, the developing apparatus includes the developing blade 15 in contact with the developing roller 14 for regulating the layer thickness of the toner 16 carried on the developing roller 14, and a contact electrically connected to the developing blade 15. When the developing apparatus is attached to a main body of an electrophotographic apparatus, the contact is electrically connected to the main body contact of the main body of the electrophotographic apparatus, thereby allowing a predetermined voltage to be applied to the developing blade 15. The volume resistivity of the developing blade 15 is preferably 1.0×10⁶ Ω cm or less. Thus, the developing blade 15 forms a layer of the toner 16 with uniform thickness on the developing roller 14, and at the same time, allows charge injection from the developing blade 15 into the toner, thereby facilitating uniform control of the charge quantity of the toner.

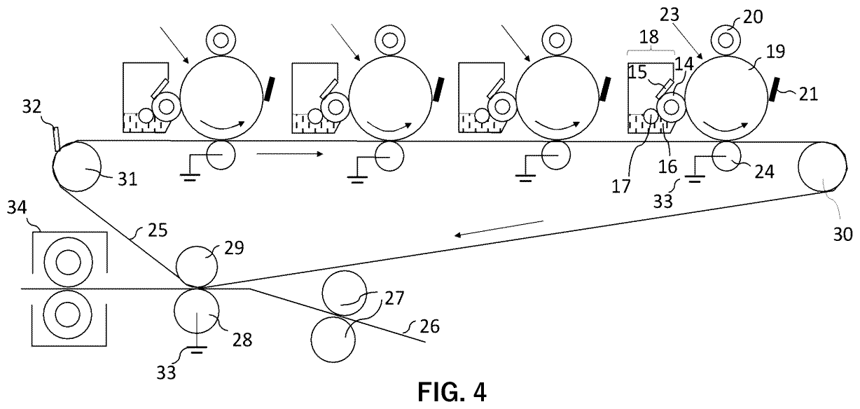

The electrophotographic image forming apparatus includes the developing apparatus according to the present disclosure. FIG. 4 is a schematic sectional view illustrating an example of an electrophotographic image forming apparatus including a contact type developing apparatus in which a one-component toner is used.

The developing apparatus 18 includes the toner 16 as a one-component toner, the developing roller 14, the toner supply roller 17 that supplies the toner to the developing roller 14, and the developing blade 15 that regulates the thickness of a toner layer on the developing roller 14. The developing roller 14 is located in an opening extending in the longitudinal direction in the developing apparatus 18, and is placed in contact with the photosensitive member 19. It is to be noted that the photosensitive member 19, the charging roller 20, and the cleaning blade 21 may be provided in the main body of the electrophotographic image forming apparatus. The developing apparatus 18 has respective color toners of black, cyan, magenta, and yellow prepared, thereby allowing color printing.

The printing operation of the electrophotographic image forming apparatus will be described below. The photosensitive member 19 rotates in the direction of an arrow to be uniformly charged by the charging roller 20 for charging the photosensitive member 19. Next, an electrostatic latent image is formed on the surface of the photosensitive member 19 with laser light 23, which is an exposure means. The electrostatic latent image is visualized (developed) as a toner image by the developing apparatus 18 with the toner 16 provided from the developing roller 14 disposed in contact with the photosensitive member 19. The development is a so-called reversal development in which a toner image is formed on an exposed part.

The toner image formed on the photosensitive member 19 is transferred to an endless belt-shaped intermediate transfer member 25 by a transfer roller 24, which is a transfer member.

A paper sheet 26, which is a recording medium, is fed into the apparatus by a paper feed roller 27 and a secondary transfer roller 28, and is transported to a nip part between the secondary transfer roller 28 and a driven roller 29 together with the intermediate transfer member 25 with toner image, and the toner image is transferred to the paper sheet 26. The intermediate transfer member 25 is operated by the driven roller 29, a driver roller 30, and a tension roller 31. The toner remaining on the intermediate transfer member 25 is cleaned by the cleaning apparatus 32.

A voltage is applied from a bias power source 33 to the developing roller 14, the developing blade 15, the transfer roller 24, and the secondary transfer roller 28. The paper sheet 26 with the toner image transferred thereto is subjected to fixing treatment by a fixing apparatus 34 and ejected to the outside of the apparatus, and the printing operation is finished. Meanwhile, the transfer residual toner remaining on the photosensitive member 19 without being transferred is scraped off by the cleaning blade 21, which is a cleaning member for cleaning the surface of a photosensitive member. The cleaned photosensitive member 19 repeats the foregoing printing operation.

Methods for measuring physical properties of the respective materials, toner, and developing roller will be described below.

### Method for Measuring Impedance of Toner and Calculation of Conductivity

The capacitance and conductivity of air and powder are measured by impedance measurement with the use of a parallel plate capacitor method.

For the apparatus, a jig for toner measurement, including a four-terminal sample holder SH2-Z (manufactured by TOYO Corporation) and a torque wrench adapter SH-TRQ-AD (optional), and a material test system ModuLab XM MTS (manufactured by Solartron) are used.

In addition, a noise cut transformer NCT-I3 1.4kVA (manufactured by DENKENSEIKI Research Institute Co., Ltd.) for suppression of commercial power source noise and a shield box for suppression of electromagnetic wave noise are used.

For a jig for powder measurement, a four-terminal sample holder and an optional torque wrench adapter SH-TRQ-AD are used, and as a parallel plate electrode, an upper electrode ((D25 mm solid electrode) SH-H25AU and a lower electrode for liquid/powder (center electrode Φ10 mm; guard electrode Φ26 mm) SH-2610AU are used, such that the configuration allows the resistance of 0.1Ω to 1T Ω to be measured for electric signals up to 500 Vp-p at DC to 1 MHz.

In addition, for adjusting the pressure of the toner sample, a torque wrench adapter SH-TRQ-AD (manufactured by TOYO Corporation) is attached to a micrometer provided in the four-terminal sample holder for use in measuring the film thickness between the upper and lower electrodes.

As a torque driver for use in control of pressurization, a torque driver RTD15CN (manufactured by Tohnichi Manufacturing Co., Ltd.) and a 6.35 mm square bit are used, such that the configuration allows control of the tightening torque to 6.5 cN-m.

For the measurement of the electrical AC characteristics, impedance measurement is performed with the use of a material test system ModuLab XM MTS (manufactured by Solartron).

The ModuLab XM MTS includes a control module XM MAT 1 MHz, a high voltage module XM MHV100, a femto-current module XM MFA, and a frequency response analysis module XM MRA 1 MHz, and XM-studio MTS Ver. 3.4 manufactured by the same company is used as control software.

The measurement conditions are set to Normal Mode in which only measurement is performed, with an AC level of 7 Vrms, a DC bias of 0 V, and a sweep frequency of 1 MHz to 0.01 Hz (12 points/decade or 6 points/decade).

Furthermore, in view of noise suppression and reduction in measurement time, the following settings are added for each sweep frequency:
sweep frequency of 1 MHz to 10 Hz and measurement integration time of 64 cycles;
sweep frequency of 10 Hz to 1 Hz and measurement integration time of 24 cycles;
sweep frequency of 1 Hz to 0.01 Hz and measurement integration time of 1 cycle.

The measurement of the impedance characteristics, which are the electrical AC characteristics of the toner, is performed under the foregoing measurement conditions.

Performing the measurement under the foregoing conditions allows the impedance characteristics of the air and sample in the case of the measurement electrode S of ΦD10 mm and the film thickness d in accordance with the pressurizing torque to be obtained with the use of the powder measurement jig based on the parallel plate capacitor method.

From the obtained impedance characteristics of the air and sample, the measurement system is subjected to data correction processing to obtain highly reliable capacitance C and conductance (conductivity) G. From the obtained capacitance C, conductance (conductivity) G, and the geometric shape (the electrode size S of the parallel plate and the sample film thickness) of the toner measurement jig, the relative dielectric constant and the conductivity, which are electrical properties, are determined.

In the case of using the four-terminal sample holder SH2-Z for the first time, there is a need for two verifications performed for finding out optimal measurement conditions, because the four-terminal sample holder SH2-Z for use as the powder measurement jig has individual differences.

The first verification is performed for the film thickness dependent characteristics of the four-terminal sample holder. The optimum range in which the measurement error is minimized or the film thickness as an optimum value is found out by measuring the dependence of the air thickness (the distance between the upper and lower electrodes) and checking the error between the theoretical value and measured value of the capacitance.

The second verification is performed for the measurement of a mechanical error. For the measurement of the toner sample, a load with the torque controlled is applied to keep the volume density constant. In contrast, the measurement of the air has no load. In this case, an error in film thickness is caused due to the influence of dimensions such as mechanical machining accuracy. Thus, the offset value between the load and non-load states of the controlled value (6.5 cN-m for the present jig) of the tightening torque is checked and regarded as an offset correction value.

Specific sample preparation and measurement procedures are as follows.

(1) On the center electrode part of the lower electrode, the toner is placed, and molded so as to have a trapezoidal shape of 5 mm in height.

(2) The lower electrode with the toner placed thereon is attached to the four-terminal sample holder SH2-Z, and the upper electrode is lowered.

(3) At this time, the upper electrode is lowered to the upper end of the toner while keeping the upper electrode steady so as not to rotate inadvertently.

(4) While rotating the upper electrode left and right, smoothing treatment is performed such that the toner becomes smooth.

(5) While adjusting the film thickness to reach a predetermined thickness with the use of a micrometer, the rotational direction of the upper electrode is maintained in a uniform constant direction.

(6) Pressurization is performed with the use of the torque driver.

(7) The sample film thickness is measured with the use of a micrometer.

(8) The impedance measurement is performed under the foregoing conditions.

(9) After the end of the measurement, the upper electrode is raised, and the lower electrode is removed. At this time, the lower electrode is removed with sufficient care such that the toner does not enter the lower-electrode contact terminal of the four-terminal sample holder, and protected with a masking tape.

(10) The upper and lower electrodes are washed.

(11) The masking tape is removed, and the lower electrode is attached.

(12) The sample film thickness d obtained in the step (7) is adjusted to be the thickness t of the air in consideration of the offset correction in the non-load state, and the rotational direction of the upper electrode is kept in a uniform constant direction.

(13) The impedance measurement of the air is performed.

(14) If the measured data (dielectric loss tangent; tan 6) of the air, measured in the step (13), is 0.002 or more in the frequency range of 100 Hz to 0.01 Hz, the washing is insufficient, and thus, the operation is performed again from the washing step of the step (10).

The measurement is performed at 25° C.

Specific data processing procedures are as follows.

(15) From the measured impedance characteristics of the air, the error of the phase characteristics relative with respect to the theoretical value is calculated to obtain phase correction data of the material testing system ModuLab XM MTS (manufactured by Solartron).

(16) The phase correction data calculated in the step (15) is applied to the impedance characteristics of the air, measured in the step (13), to obtain the impedance characteristics of the air subjected to the phase correction processing.

(17) From the admittance Ya=Ga+jωCa of the phase-corrected impedance characteristics of the air, the capacitance Ca as well as the error from the theoretical value are calculated to obtain correction data a for the error in film thickness.

(18) The phase correction processing obtained in the step (15) is applied to the impedance characteristics of the toner sample, measured in the step (8).

(19) The complex admittance Ym=Gm+jωCm of the characteristics subjected to the phase correction processing in the step (18) is subjected to calculation with the use of the capacitance Ca of the air, obtained in the step (17), and the correction data a therefor to calculate the relative dielectric constant and conductivity of the toner sample with high reliability.

The resistivity of the toner in this disclosure is the value of the reciprocal of the conductivity at a frequency of 0.01 Hz.

Measurement of Temperature of Endothermic Peak and Endothermic Quantity of Crystalline Material in Toner

The temperature of an endothermic peak of and the endothermic quantity of the crystalline material in the toner are measured with the use of a differential scanning calorimeter “Q1000” (manufactured by TA Instruments Inc.). The melting points of indium and zinc are used to correct the temperature of a detection unit of the apparatus, and the heat of fusion of indium is used to for the quantity of heat.

Specifically, 3 mg of the toner is weighed precisely, put into an aluminum pan, and an empty aluminum pan is used as a reference. The measurement is performed in the range from 0° C. to 120° C. at a ramp rate of 1° C./min and under temperature modulation conditions of ±0.6° C./60 seconds with the use of a modulation measurement mode. The maximum endothermic peak of the DSC curve in the temperature range of 30 to 200° C. in the process of temperature rise is defined as the maximum endothermic peak of the endothermic curve in the DSC measurement of the toner, and the temperature of the peak value is defined as the temperature of the endothermic peak.

In addition, the endothermic quantity is the area of an endothermic peak, calculated with the temperature at the shoulder of the endothermic peak generated at the lowest temperature and 120° C. as a baseline.

The temperature 120° C. used in setting the baseline described above is changed to 80° C., and then, the endothermic quantity at 30° C. to 80° C. is also calculated.

Measurement of Area Proportion of Crystalline Material in Cross Section of Toner

The presence state of the sea-island structure in a cross section of the toner is confirmed by observing the cross section of the toner with the use of a scanning transmission electron microscope. The cross section of the toner is observed after performing ruthenium staining. The procedure of observing the cross section of the toner is as follows.

The toner is embedded with a visible light curable resin (D-800, manufactured by New EM Co., Ltd.) in a manner that the toner is dispersed as much as possible, and cut into a thickness of 100 nm with an ultrasonic ultramicrotome (UC7, manufactured by Leica Microsystems Inc.).

The obtained thin-film sample is stained for 15 minutes with the use of a vacuum staining apparatus (VSC4R1H, manufactured by Filgen, Inc.) in a RuO₄ gas 500 Pa atmosphere, and a STEM image is acquired with the use of a scanning transmission electron microscope (JEM 2800, JEOL Ltd.). Under the staining conditions mentioned above, a difference in the degree of staining is caused between the crystalline material and the amorphous resin, and thus, the presence state of the sea-island structure can be confirmed with the contrast difference.

The crystalline material is more stained with ruthenium than the amorphous resin. Because the amount of ruthenium atoms varies depending on the intensity of staining, a strongly stained part has many of the atoms in black on the observed image without transmitting electron beams, whereas a weakly stained part is likely to transmit electron beams and thus in white on the observed image. As described above, a contrast difference is caused between the crystalline material and the amorphous resin part, and the presence state can be thus confirmed.

As conditions for the observation, the acceleration voltage, the probe size of the STEM, the image size, and the magnification are set, respectively, to 200 kV, 1 nm, 1024×1024 pixels, and 30,000, and a dark field (STEM-DF) image is acquired.

The contrast and the brightness are adjusted such that the brightness is 150 when a part containing the resin component as a main component has a maximum number of pixels in a brightness histogram in accordance with IMAGE J below.

Further, in the case of 140 to 160, the brightness can be adjusted with Microsoft Photo.

In the case of the brightness other than the foregoing, the staining conditions are changed again, and the STEM image is obtained again.

In this regard, in selecting the cross-sectional image of the toner, the weight-average particle diameter (D4) of the toner is measured by the measurement method described later, and then, ten cross sections of the toner with major axis diameters 0.8 to 1.1 times as large as the D4 are selected. In addition, the image is acquired so as to avoid two or more toners in the field of view of one image.

The brightness histogram is acquired by analyzing the STEM image of the toner cross section, obtained by the method mentioned above, with the use of image processing software Image J (developer: Wayne Rashand). More specifically, the brightness histogram is a brightness histogram obtained by measuring a brightness spectrum that has 256 gradations for an image obtained from an image analysis of the toner cross section. The specific procedure will be presented below.

First, from the Type of the Image menu, the backscattered electron image to be analyzed is converted to 8-bit.

Next, the range to be analyzed is designated only inside the contour of the toner. In this regard, the contour of the toner is regarded as the boundary line between the visible light curable resin and the toner cross section. The outside of the range to be analyzed is erased by the Clear Outside of the Edit menu.

From the Filters in the Process menu, the Median diameter is set to 2.0 pixels to reduce the image noise.

Next, from the Adjust of the Image menu, the Threshold is selected, the position of the lower bar is set to 150, and the Apply is selected. The List is displayed, and the white ratio is calculated from the number of 0 pixels to the total number of pixels. This white ratio is defined as the area proportion of the crystalline material.

Ten STEM images for each toner cross section are subjected to the same image analysis, and the value mentioned above is calculated. The arithmetic mean of the ten respective values obtained is defined as a physical property value for each toner.

Method for Confirming Sea-Island Structure and Measuring Dispersion Diameter

The sea-island structure has, for example, in a cross-sectional image of the toner, a continuous sea in the image and islands divided by the sea.

In the STEM image of the toner cross section, the continuous part stained in black is defined as an island of the crystalline material. The major and minor diameters of the island of the crystalline material are measured, and the average of the values of the major diameters in all of the toner observed is defined as the average particle diameter of the crystalline material.

In addition, in the STEM image of the toner cross section, a divided part that is not stained in black is defined as a sea of the amorphous resin.

Regarding the sea-island structure, specifically, regarding the ten STEM images of the toner cross section, when two or more islands divided by the sea are observed as described above, it is determined that the image has the sea-island structure.

### Method for Measuring Volume-Average Particle Diameter (Dv)

The volume-average particle diameter (Dv) of the toner is calculated as follows. A particle counting analyzer “CDA-1000X” (manufactured by SYSMEX CORPORATION) in accordance with a pore electrical resistance method, including an aperture tube of 100 μm, is used as a measurement apparatus. Appended dedicated software “CDA-1000X (manufactured by SYSMEX CORPORATION)” is used for setting the measurement conditions and analyzing measurement data.

For example, “CELLPACK” (manufactured by SYSMEX CORPORATION) can be used for an aqueous electrolytic solution for use in the measurement.

It is to be noted that before performing the measurement and the analysis, the dedicated software is set as follows.

On the “measurement condition setting” screen of the dedicated software, the total count number is set to 50,000, the number of repeated measurements is set to one, and the measurement mode is set to total count (no limitation).

A specific measurement method is as follows.

(1) About 150 ml of the aqueous electrolytic solution is put in a dedicated glass round-bottom beaker, set on a sample stage, and stirred with a stirring propeller at 500 rpm. Then, the “blank check measurement” of the dedicated software is clicked to start the measurement, and confirm that the count number is less than 500. If the count number is 500 or more, the beaker and the aperture tube are repeatedly washed.

(2) The aqueous electrolytic solution: 30 ml is put into a 100 ml flat-bottom glass beaker. To this solution, 0.3 ml of a diluted solution prepared by diluting “Contaminon N” (a 10% by mass aqueous solution of a neutral detergent with pH 7 for washing precision measurement instruments, including a nonionic surfactant, an anionic surfactant, and an organic builder, manufactured by Wako Pure Chemical Industries, Ltd.) with ion exchanged water to 3 times by mass is added as a dispersing agent.

(3) An ultrasonic disperser “Ultrasonic Dispension System Tetra 150” with an electrical output of 120 W (manufactured by Nikkaki Bios Co., Ltd.) is prepared in which two oscillators with an oscillation frequency of 50 kHz are incorporated with phases shifted by 180 degrees. About 3.3 l of ion exchanged water is put into a water tank of the ultrasonic disperser, and 2 ml of the Contaminon N is added to this water tank.

(4) The beaker in (2) is set in a beaker fixing hole of the ultrasonic disperser, and the ultrasonic disperser is operated. Then, the height position of the beaker is adjusted so as to maximize the resonance state of the liquid surface of the aqueous electrolytic solution in the beaker.

(5) While the aqueous electrolytic solution in the beaker in (4) is irradiated with ultrasonic waves, 10 mg of the toner is added little by little and dispersed. Then, the ultrasonic dispersion treatment is further continued for 60 seconds. Further, for the ultrasonic dispersion, the water temperature in the water tank is appropriately adjusted to be from 10° C. to 40° C.

(6) To the round-bottom beaker in (1) placed in the sample stand, the aqueous electrolytic solution in (5) in which the toner is dispersed is added dropwise with a pipette, and the measurement concentration is adjusted to be 6%. Then, the measurement is performed until the number of measurement particles reaches 50,000.

(7) The measurement data is analyzed with the dedicated software appended to the apparatus to calculate the volume-average particle diameter (Dv).

### Composition Analysis of Toner

—Separation of Toner Particle from Toner

The toner particle obtained by separating the toner particle and the external additives can be used for each analysis by the following method.

Sucrose (manufactured by Kishida Chemical Co., Ltd.): 160 g is added to 100 mL of ion exchanged water and dissolved in a hot water bath to prepare an aqueous sucrose solution. Into a centrifuge tube, 31 g of the aqueous sucrose solution and 6 mL of Contaminon N (a 10% by mass aqueous solution of a neutral detergent with pH 7 for washing precision measurement instruments, including a nonionic surfactant, an anionic surfactant, and an organic builder, manufactured by FUJIFILM Wako Pure Chemical Corporation) are put to prepare a dispersion. To this dispersion, 1 g of the toner is added, and the toner lump is loosened with a spatula or the like.

The centrifuge tube is set in “KM Shaker” (model: V.SX) manufactured by IWAKI INDUSTRY CO., LTD., and shaken under the condition of 350 reciprocations per minute for 20 minutes. After the shaking, the solution is transferred into a glass tube (50 mL) for a swing rotor, and centrifuged under the condition of 3,500 rpm for 30 minutes in a centrifuge (H-9R manufactured by KOKUSAN Co., Ltd.).

In the glass tube after the centrifugation, the toner particle is present in the uppermost layer, whereas the external additives such as silica fine particles are present on the aqueous solution side of the lower layer. The toner particle in the upper layer is collected and filtered, and washed by passing of 2 L of ion exchanged water warmed to 40° C., and the washed toner particle is taken out.

—Method of Separating Chloroform-Soluble Matter and Chloroform-Insoluble Matter (Crystalline Resin) from Toner Particle

The toner particle: 1.5 g is precisely weighed, put in a cylindrical filter paper (Trade Name: No. 86R, Size: 28×100 mm, manufactured by Advantec Toyo Kaisha, Ltd.) precisely weighed in advance, and set in a Soxhlet extractor. Extraction is performed for 18 hours with the use of 200 mL of chloroform as a solvent, at a reflux rate such that the extraction cycle of the solvent is once every 5 minutes approximately.

After the completion of the extraction, the cylindrical filter paper is taken out and air-dried, then vacuum-dried at 40° C. for 8 hours, and from the weighed mass of the cylindrical filter paper containing the extraction residue, the mass of the cylindrical filter paper is subtracted to confirm the mass of the extraction residue (chloroform insoluble matter (crystalline resin)), thereby confirming that the insoluble matter can be collected. In the case of collecting the chloroform-soluble matter, the matter can be collected by sufficiently distilling off the chloroform from the soluble matter in the chloroform with an evaporator.

—Method of Separating Amorphous Resin and Wax from Chloroform-Soluble Matter

In the separation of the amorphous resin and the wax, a component that has a molecular weight of 2,000 or less is separated as a wax by recycle HPLC. The measurement method is presented below. First, the chloroform-soluble matter is separated by the method described above, and dissolved in chloroform. Then, the obtained solution is filtered through a solvent resistant membrane filter “MAISHORIDISC” (manufactured by Tosoh Corporation) of 0.2 μm in pore diameter to obtain a sample solution. Further, the sample solution is adjusted such that the concentration of the component that is soluble in the chloroform is 1.0% by mass. The sample solution is used to perform measurement under the following conditions.
Apparatus: LC-Sakura NEXT (manufactured by Japan Analytical Industry Co., Ltd.)
Column: JAIGEL2H, 4H (manufactured by Japan Analytical Industry Co., Ltd.)
Eluent: chloroform
Flow Rate: 10.0 mL/min
Oven Temperature: 40.0° C.
Sample Injection Amount: 1.0 mL

In the calculation of the molecular weight of the sample, a molecular weight calibration curve is used, which is created with the use of standard polystyrene resins (for example, trade names “TSK standard polystyrene F-850, F-450, F-288, F-128, F-80, F-40, F-20, F-10, F-4, F-2, F-1, A-5000, A-2500, A-1000, and A-500” manufactured by Tosoh Corporation).

From the molecular weight curve thus obtained, a component that has a molecular weight of 2,000 or less is repeatedly subjected to preparative separation to separate the amorphous resin component and the wax component in the chloroform-soluble matter of the toner.

—Identification of Components of and Measurement of Mass Ratio between Amorphous Resin and Crystalline Material by Nuclear Magnetic Resonance Spectroscopy (NMR)

To 20 mg of each of the amorphous resin, the wax, and the crystalline resin, 1 mL of deuterated chloroform is added, and ¹H-NMR is performed under the following conditions.

Measurement Apparatus: FT NMR apparatus JNM-EX400 (commercially available from JEOL Ltd.)

Measurement Frequency: 400 MHz

Pulse Condition: 5.0 s

Frequency Range: 10,500 Hz

Accumulation Count: 64 times

Measurement Temperature: 30° C.

Sample: prepared as follows

Into a sample tube of 5 mm in inner diameter, 50 mg of a measurement sample is put, with deuterated chloroform (CDCl₃) is added thereto as a solvent, and dissolved in a thermostatic chamber at 40° C. to prepare a sample.

The obtained ¹H-NMR chart is analyzed to identify the structure of each unit.

When a monomer containing no hydrogen atom is used as a constituent element other than the vinyl group, the measurement can be performed in a single pulse mode with the measured atomic nucleus set to ¹³C with the use of ¹³C-NMR, thereby performing the calculation similarly in accordance with ¹H-NMR. The proportion (mol %) of each unit, calculated by the method described above, is multiplied by the molecular weight of each unit to convert the content ratio of each unit into % by mass.

### Measurement of Impedance of Developing Roller

The impedance of the developing roller was measured as follows.

First, as a pretreatment, the developing roller was subjected to vacuum platinum vapor deposition while rotating the developing roller, thereby preparing a measurement electrode. For the vapor deposition, a vacuum vapor deposition apparatus that has a mechanism for holding a substrate part of the roller as an object to be subjected to the deposition and rotating the roller in a circumferential direction was used to control the roller rotation speed, the vapor deposition distance, and the vapor deposition time, and performed vapor deposition such that the film thickness is 100 nm or more. At this time, an electrode of 1.5 cm in width was prepared with the use of a masking tape. Forming the electrode with a film thickness of 100 nm or more, allowed the contribution of the area of contact between the measuring electrode and the developing roller to be reduced as much as possible by the surface roughness of the developing roller.

Next, an aluminum sheet was wound around the electrode without any gap, and the aluminum sheet was connected to measurement electrodes of impedance measurement apparatuses (Trade Name: Solartron 1260 and Solartron 1296, manufactured by Solartron) and high-voltage systems (Trade Name: 6792 and HVA-500, manufactured by TOYO Corporation).

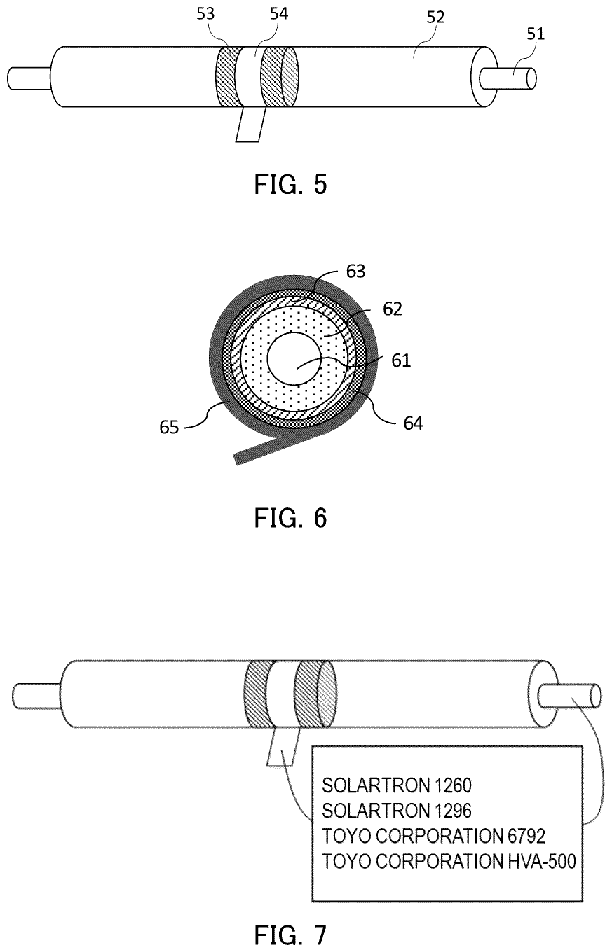

FIG. 5 illustrates a schematic view of a measurement electrode formed on a developing roller. In FIG. 5, reference numeral 51 denotes a conductive substrate, reference numeral 52 denotes a resin layer, reference numeral 53 denotes a platinum vapor deposition layer, and reference numeral 54 denotes an aluminum sheet. Although no elastic layer is illustrated in the drawing, the elastic layer is present between the substrate 51 and the resin layer 52.

FIG. 6 illustrates a sectional view of a measurement electrode formed on the developing roller. Reference numeral 61 denotes a conductive substrate, reference numeral 62 denotes an elastic layer, reference numeral 63 denotes a resin layer, reference numeral 64 denotes a platinum vapor deposition layer, and reference numeral 65 denotes an aluminum sheet. As in FIG. 6, it is important to sandwich the resin layer between the conductive substrate and the measuring electrode.

Then, the aluminum sheet was connected to the measurement electrodes of the impedance measurement apparatuses (Trade Name: Solartron 1260 and Solartron 1296, manufactured by Solartron) and high-voltage systems (Trade Name: 6792 and HVA-500, manufactured by TOYO Corporation). FIG. 7 illustrates a schematic view of the measurement system. Impedance measurement was performed with the conductive substrate and the aluminum sheet as two electrodes for the measurement.

In the impedance measurement, a DC voltage of 50 V and an AC voltage of 50 V were applied in an environment at a temperature of 23° C. and a relative humidity of 50%, and the absolute value of impedance was obtained at a frequency of 1.0×10⁻¹ to 1.0×10⁵ Hz. Then, the impedance Z at a frequency of 1.0×10² Hz, the phase θ1 at a frequency of 1.0×10² Hz, and the phase θ2 at a frequency of 1.0×10⁴ Hz were obtained.

### Surface Potential

Under an environment at a temperature of 23° C. and a relative humidity of 50%, a corona discharger that has a grid part of 3.0 mm in width is disposed such that the distance between the grid part and the outer surface of the developing roller is 1.0 mm, and that the direction of the width of the grid part is aligned with the axial direction of the developing roller, the outer surface of the developing roller is charged by applying a voltage of 8 kV to the grid part, and relatively moving the corona discharger at a speed of 400 mm/sec in the axial direction of the developing roller, and the potential of the outer surface after 0.06 seconds from the passage of the grid part is measured to evaluate the degree of excessive charging (charge-up) of the toner.

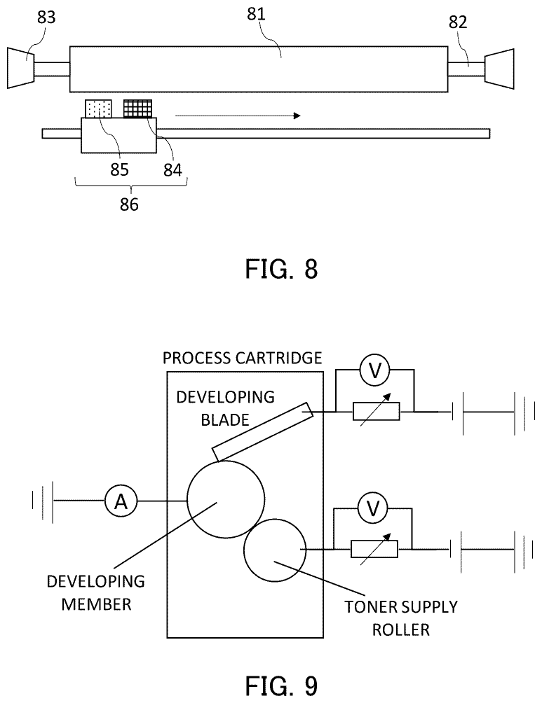

The surface potential of the developing roller can be measured with the apparatus illustrated in FIG. 8, for example. Both ends of a substrate 82 of a developing roller 81 are held with chucks 83, and a measurement unit 86 in which a corona discharger 84 and a surface electrometer 85 are arranged in parallel at an interval of 25 mm is disposed to face the surface of the developing roller 81 at an interval of 1.0 mm in distance. With the developing roller 81 kept stationary, a voltage of 8 kV is applied to the grid part of the corona discharger 84, the measurement unit 86 is moved at a speed of 400 mm/sec in the axial direction of the developing roller 81, and the surface potential after 0.06 seconds from the passage of the corona discharger 84 is measured with the surface electrometer 85.

When the voltage of 8 kV is applied to the grid part, and when the corona discharger is relatively moved at the speed of 400 mm/sec in the axial direction of the developing roller, the potential of the outer surface of the developing roller is checked after 0.06 seconds from the passage of the corona discharger.

As long as the maximum value of the potential of the outer surface is less than 20.0 V, image defects due to excessive charging of the toner can be kept from being caused, even in an electrophotographic image forming apparatus with a high process speed, in which the time is shorter until the toner charged by the developing blade is transported to the photosensitive member. It is to be noted that the condition after 0.06 seconds from the passage of the grid part of the corona discharger imitates a model with a high process speed.

### Measurement of Number Average Diameter of Primary Particle of Conductive Fine Particle

The number average diameter of primary particles of the conductive fine particles dispersed in the resin was measured with a transmission electron microscope (TEM). First, a sliced sample was prepared. Known methods were able to be used for the slicing. For example, the sample can be sliced with an ion beam, a diamond knife, or the like. In the present disclosure, a 40 nm thick sliced sample for observation was prepared with the use of an ultramicrotome (Trade Name: ULTRACUT-S, manufactured by Leica Microsystems, Inc.).

Then, with the use of a transmission electron microscope (Trade Name: H-7100FA, manufactured by Hitachi High-Tech Corporation), a TEM image was acquired under the measurement conditions of: a TE mode; and an acceleration voltage of 100 kV.

Then, for the obtained TEM image, the circle-equivalent diameters of fifty primary particles of selected conductive fine particles were measured with the use of image analysis software (Trade Name: WinROOF, manufactured by MITANI CORPORATION), and the number average value of the fifty primary particles was defined as the number average diameter of the primary particles.

### Measurement of DBP Absorption Amount of Carbon Black

The DBP absorption amount of the carbon black was, for a powder of the carbon black, measured in accordance with the Japan Industrial Standard (JIS) K6217-4.

### Measurement of pH of Carbon Black

The pH of the carbon black was, for a powder of the carbon black, measured in accordance with ASTM D1512.

Calculation of Respective Physical Properties such as Circle-Equivalent Diameter and Wall-to-Wall Distance of Conductive Fine Particle Dispersed in Resin Layer

The circle-equivalent diameter and wall-to-wall distance of the conductive fine particles dispersed in the resin layer were measured by the following method.

First, a slice (0.5 to 1.0 mm in thickness) was cut out with the use of a razor such that a cross-section perpendicular to the longitudinal direction of the developing roller can be observed. If cutting out the slice with a razor is difficult due to high adhesiveness between the substrate and the surface layer, the whole substrate is cut out with a metal saw or the like, and then, processing for a cross section is performed with a focused ion beam (FIB) apparatus.

Then, platinum is deposited on the slice, and with the use of a scanning electron microscope (Trade Name: JSM-7800F, manufactured by JEOL Ltd.), the resin layer is photographed at a magnification of 15,000 to obtain a cross-sectional image.

Furthermore, for quantifying the cross-sectional image obtained by the observation with the SEM, the cross-sectional image is subjected to 8-bit gray scaling with the use of image processing software (Trade Name: Luzex AP, manufactured by NIRECO CORPORATION) to obtain a 256-gradation monochrome image. Then, after the black and white of the image are subjected to reverse processing such that the carbon black in the cross-sectional image is turned into white, a threshold value for binarization is set for the brightness distribution of the image, based on the algorithm of Otsu's discriminant analysis method, to obtain a binarized image with the conductive fine particles in white and the binder resin part in black.

Then, for the obtained binarized image, the circle-equivalent diameter of and distance between adjacent walls of the part of conductive fine particles in white are calculated with the use of image processing software (Trade Name: Luzex AP, manufactured by NIRECO CORPORATION). The image region for calculating the circle-equivalent diameter and the distance between adjacent walls is set to a region of 0.075 μm inside (If there is a text section that mentions SEM measurement conditions or the like, 0.075 μm inside from the start of the actual image) in the actual image dimensions for eliminating the uncertainty of calculated values for conductive fine particles divided at the top, bottom, left and right ends of the image, and the circle-equivalent diameter and the distance between adjacent walls are calculated for all of the conductive fine particles in the designated image region.

Then, the arithmetic mean and the standard deviation are calculated for the distributions of the obtained circle-equivalent diameter and distance between adjacent walls.

For eliminating the influence of, for example, differences in location in the longitudinal direction, of the conductive fine particles dispersed in the resin layer of the developing roller, with ten parts obtained by dividing equally in the longitudinal direction of the developing roller, and the arithmetic means of the circle-equivalent diameters and distances between adjacent walls of slices at the ten sites are defined respectively as the circle-equivalent diameter and distance between adjacent walls in the present disclosure.

Measurement of Weight-Average Molecular Weight (Mw) and Number Average Molecular Weight of Raw Material

The apparatus and conditions for use in measuring the weight-average molecular weight (Mw) and the number average molecular weight (Mn) of raw materials such as resins were as follows:

Measurement Apparatus: HLC-8120 GPC (manufactured by Tosoh Corporation)

Column: TSKgel Super HZMM (manufactured by Tosoh Corporation)×2

Solvent: Tetrahydrofuran (THF) (20 mmol/l triethylamine added)

Temperature: 40° C.

Flow Rate of THF: 0.6 ml/min

Further, the measurement sample was a 0.1% by mass solution in THF.

Furthermore, the measurement was performed with the use of an RI (refractive index) detector as a detector.

Calibration curves were created with the use of TSK standard polystyrenes A-1000, A-2500, A-5000, F-1, F-2, F-4, F-10, F-20, F-40, F-80, and F-128 manufactured by Tosoh Corporation as standard samples for calibration curve creation. Based on these calibration curves, the weight-average molecular weight and the number average molecular weight were determined from the retention time of the obtained measurement sample.

### EXAMPLES

Specific descriptions will be provided below with reference to examples. It is to be noted that, unless otherwise specified, “part(s)” are “part(s) by mass” on a mass basis in the following formulations.

### Preparation of Crystalline Resin 1

The following materials were put into a reaction container provided with a reflux cooling tube, a stirrer, a thermometer, and a nitrogen inlet tube under a nitrogen atmosphere.
toluene: 100.0 parts
monomer composition: 100.0 parts
(the monomer composition is a mixture of the following monomers in the following proportions)
(behenyl acrylate: 60.0 parts)
(styrene: 20.0 parts)
(methacrylonitrile: 10.0 parts)
(N-vinyl-2-pyrrolidone: 10.0 parts)
polymerization initiator: 0.5 parts of t-butyl peroxypivalate (Perbutyl PV, manufactured by NOF Corporation)

While stirring the materials in the reaction container at 200 rpm, the materials were heated to 70° C. to cause a polymerization reaction for 12 hours and obtain a solution in which a polymer in the monomer composition was dissolved in toluene. Subsequently, the temperature of the solution was lowered down to 25° C., and then, the solution was put into 1000.0 parts of methanol while stirring to precipitate a methanol-insoluble matter. The obtained methanol-insoluble matter was separated by filtration, further washed with methanol, and then vacuum-dried at 40° C. for 24 hours to obtain a crystalline resin 1. Physical properties of the crystalline resin 1 are shown in Table 1.

### Preparation of Crystalline Resins 2 to 3

Crystalline resins 2 and 3 were prepared in the same manner as in the preparation of crystalline resin 1 except that the amount of the monomer composition added was changed to Table 1. Physical properties of the crystalline resins 2 and 3 are shown in Table 1.

TABLE 1

| | Monomer (a) | | | | | | | | | | |
|---|---|---|---|---|---|---|---|---|---|---|---|
| | | Number | | Another Monomer 1 | | Another Mononer 2 | | Another Monomer 3 | | Polymerization | |
| | | of | Added | | Added | | Added | | Added | Initiator | Molecular |
| Crystalline | | Carbon | Amount | | Amount | | Amount | | Amount | Added Amount | Weight |
| Resin No. | Type | Atoms n | (Parts) | Type | (Parts) | Type | (Parts) | Type | (Parts) | (Parts) | Mw |
| 1 | Behenyl | 21 | 60.0 | Styrene | 20.0 | Acrylonitrile | 10.0 | N-vinyl-2- | 10.0 | 0.5 | 30200 |
| | acrylate | | | | | | | pyrrolidone | | | |
| 2 | Behenyl | 21 | 60.0 | Styrene | 27.5 | Acrylonitrile | 10.0 | Acrylic acid | 2.5 | 0.5 | 34000 |
| | acrylate | | | | | | | | | | |
| 3 | Behenyl | 21 | 60.0 | Styrene | 20.0 | Acrylonitrile | 20.0 | — | — | 0.5 | 29860 |
| | acrylate | | | | | | | | | | |

### Polymerization Initiator: T-Butyl Peroxypivalate (Manufactured by NOF Corporation: Perbutyl PV)

### Production of Toner

### Production of Toner 1

A mixture of the following materials was prepared.
styrene: 45.0 parts
n-butyl acrylate: 15.0 parts
carbon black: 6.5 parts
aluminum di-t-butylsalicylate: 0.1 parts

The mixture was put into an attritor (manufactured by NIPPON COKE & ENGINEERING CO., LTD.), and dispersed at 200 rpm for 2 hours with the use of zirconia beads of 5 mm in diameter to obtain a raw material dispersion.

On the other hand, 735.0 parts of ion exchanged water and 16.0 parts of trisodium phosphate (12 hydrate) were added to a container provided with a high-speed stirrer Homo Mixer (manufactured by PRIMIX Corporation) and a thermometer, and while stirring the mixture at 12,000 rpm, the temperature was raised to 60° C. To the mixture, an aqueous calcium chloride solution obtained by dissolving 9.0 parts of calcium chloride (2 dihydrate) in 65.0 parts of ion exchanged water was added, and the mixture was stirred at 12,000 rpm for 30 minutes while maintaining 60° C. To the mixture, 10% hydrochloric acid was added to adjust the pH to 6.0, thereby providing an aqueous medium in which an inorganic dispersion stabilizer containing hydroxyapatite was dispersed in water.

Subsequently, the raw material dispersion was transferred into a container provided with a stirrer and a thermometer, and the temperature was raised to 60° C. while stirring the dispersion at 100 rpm.
Crystalline Resin 1: 45.0 parts
Paraffin wax HPN51 with a melting point of 78° C., manufactured by NIPPON SEIRO CO., Ltd.: 9.0 parts
HDDA (hexanediol diacrylate) 0.2 parts

After the temperature was raised to 60° C., the mixture with the foregoing materials added was stirred at 100 rpm for 30 minutes while maintaining 60° C. Then, the mixture with 8.0 parts of t-butyl peroxypivalate (manufactured by NOF Corporation: Perbutyl PV) added as a polymerization initiator was further stirred for 1 minute, and then put into an aqueous medium stirred at 12,000 rpm with the high-speed stirrer. The stirring was continued at 12,000 rpm for 20 minutes with the high-speed stirrer while maintaining 60° C. to obtain a granulating liquid.

The granulating liquid was transferred into a reaction container provided with a reflux cooling tube, a stirrer, a thermometer, and a nitrogen inlet tube, and the temperature was raised to 76° C. while stirring the liquid at 150 rpm under a nitrogen atmosphere. Causing a polymerization reaction at 150 rpm for 6 hours while maintaining 76° C. produced a toner particle dispersion.

The obtained toner particle was heated up to 80° C., held for 30 minutes, then cooled from 80° C. to 50° C. at a rate of 10° C./sec, and thereafter, subjected to annealing treatment for 10 hours at 50° C. maintained while stirring at 150 rpm. After the annealing treatment, the toner particle was slowly cooled to room temperature, and then, with the stirring maintained, a dilute hydrochloric acid was added to dissolve the dispersion stabilizer until the pH reached 1.5. The solid content was filtered off, sufficiently washed with ion exchanged water, then vacuum-dried at 30° C. for 24 hours, and subjected to classification with an inertial classification system of Elbow-Jet classifier (manufactured by Nittetsu Mining Co., Ltd.) to obtain a toner particle 1 of 6.5 μm in volume average particle diameter.

To 98.0 parts of the toner particle 1, 2.0 parts of silica fine particles (subjected to hydrophobic treatment with hexamethyldisilazane, number-average particle diameter of primary particles: 10 nm, BET specific surface area: 170 m²/g) was added as an external additive, and then mixed at 3,000 rpm for 15 minutes with the use of a Henschel mixer (manufactured by NIPPON COKE & ENGINEERING CO., LTD.) to obtain a toner 1. Physical properties and the like of the obtained toner 1 are shown in Table 4.

### Production Examples of Toners 2 and 3

Toners 2 and 3 were obtained in the same manner as in the production example of the toner 1 except for the changes shown in Table 2. Physical properties of the obtained toners 2 and 3 are shown in Table 4.

TABLE 2

| | Resin | | | | | | | | |
|---|---|---|---|---|---|---|---|---|---|
| | | | Polymerizable | | Polymerizable | | | | Polymerization |
| | Crystalline Resin | | Monomer 1 | | Monomer 2 | | Crosslinking Agent | | Initiator |
| | | Added | | Added | | Added | | Added | Added |
| Toner | | Amount | | Amount | | Amount | | Amount | Amount |
| No. | Type | (Parts) | Type | (Parts) | Type | (Parts) | Type | (Parts) | (Parts) |
| 1 | Resin 1 | 40.0 | Styrene | 45.0 | n-butyl | 15.0 | HDDA | 0.2 | 8.0 |
| | | | | | acrylate | | | | |
| 2 | Resin 2 | 40.0 | Styrene | 45.0 | n-butyl | 15.0 | HDDA | 0.2 | 8.0 |
| | | | | | acrylate | | | | |
| 3 | Resin 3 | 40.0 | Styrene | 45.0 | n-butyl | 15.0 | HDDA | 0.2 | 8.0 |
| | | | | | acrylate | | | | |

| | Pigment | | Release Agent | | | | | |
|---|---|---|---|---|---|---|---|---|
| | | Added | | Added | Reaction | | Cooling Condition | |
| Toner | | Amount | | Amount | Temperature | Time | Cooling | |
| No. | | (Parts) | Type | (Parts) | (° C.) | (hours) | Rate | Annealing |
| 1 | Carbon black | 6.5 | Paraffin wax (HPN51: | 9.0 | 76.0 | 6.0 | 10° C./sec | Yes |
| | | | melting point 78° C.) | | | | | |
| 2 | Carbon black | 6.5 | Paraffin wax (HPN51: | 9.0 | 76.0 | 6.0 | 10° C./sec | Yes |
| | | | melting point 78° C.) | | | | | |
| 3 | Carbon black | 6.5 | Paraffin wax (HPN51: | 9.0 | 76.0 | 6.0 | 10° C./sec | Yes |
| | | | melting point 78° C.) | | | | | |

### Production Example of Toner 4

A mixture of the following materials was prepared.
styrene: 75.0 parts
n-butyl acrylate: 25.0 parts
carbon black: 6.5 parts
aluminum di-t-butylsalicylate: 0.1 parts

The mixture was put into an attritor (manufactured by NIPPON COKE & ENGINEERING CO., LTD.), and dispersed at 200 rpm for 2 hours with the use of zirconia beads of 5 mm in diameter to obtain a raw material dispersion.

On the other hand, 735.0 parts of ion exchanged water and 16.0 parts of trisodium phosphate (12 hydrate) were added to a container provided with a high-speed stirrer Homo Mixer (manufactured by PRIMIX Corporation) and a thermometer, and while stirring the mixture at 12,000 rpm, the temperature was raised to 60° C. To the mixture, an aqueous calcium chloride solution obtained by dissolving 9.0 parts of calcium chloride (2 dihydrate) in 65.0 parts of ion exchanged water was added, and the mixture was stirred at 12,000 rpm for 30 minutes while maintaining 60° C. To the mixture, 10% hydrochloric acid was added to adjust the pH to 6.0, thereby providing an aqueous medium in which an inorganic dispersion stabilizer containing hydroxyapatite was dispersed in water.

Subsequently, the raw material dispersion was transferred into a container provided with a stirrer and a thermometer, and the temperature was raised to 60° C. while stirring the dispersion at 100 rpm.
FCA-5 (Trade Name, manufactured by Fujikura Kasei Co., Ltd.): 2.0 parts
dipentaerythritol stearate wax with a melting point of 79° C., manufactured by The Nisshin OilliO Group, Ltd.: 35.0 parts
HDDA (hexanediol diacrylate): 0.2 parts

After the temperature was raised to 60° C., the mixture with the foregoing materials added was stirred at 100 rpm for 30 minutes while maintaining 60° C. Then, the mixture with 10.0 parts of t-butyl peroxypivalate (manufactured by NOF Corporation: Perbutyl PV) added as a polymerization initiator was further stirred for 1 minute, and then put into an aqueous medium stirred at 12,000 rpm with the high-speed stirrer. The stirring was continued at 12,000 rpm for 20 minutes with the high-speed stirrer while maintaining 60° C. to obtain a granulating liquid.

The granulating liquid was transferred into a reaction container provided with a reflux cooling tube, a stirrer, a thermometer, and a nitrogen inlet tube, and the temperature was raised to 76° C. while stirring the liquid at 150 rpm under a nitrogen atmosphere. Causing a polymerization reaction at 150 rpm for 6 hours while maintaining 76° C. produced a toner particle dispersion.

The obtained toner particle was heated up to 80° C., held for 30 minutes, then cooled from 80° C. to 50° C. at a rate of 10° C./sec, and thereafter, subjected to annealing treatment for 10 hours at 50° C. maintained while stirring at 150 rpm. After the annealing treatment, the toner particle was slowly cooled to room temperature, and then, with the stirring maintained, a dilute hydrochloric acid was added to dissolve the dispersion stabilizer until the pH reached 1.5. The solid content was filtered off, sufficiently washed with ion exchanged water, and then vacuum-dried at 30° C. for 24 hours to obtain a toner particle 4.

To 98.0 parts of the toner particle 4, 2.0 parts of silica fine particles (subjected to hydrophobic treatment with hexamethyldisilazane, number-average particle diameter of primary particles: 10 nm, BET specific surface area: 170 m²/g) was added as an external additive, and then mixed at 3,000 rpm for 15 minutes with the use of a Henschel mixer (manufactured by NIPPON COKE & ENGINEERING CO., LTD.) to obtain a toner 4. Physical properties of the obtained toner 4 are shown in Table 3.

### Production Examples of Toners 5 to 12

Toners 5 to 12 were obtained in the same manner as in the production example of the toner 4 except for the changes were made as shown in Table 3. Physical properties of the obtained toners 5 to 12 are shown in Table 4.

TABLE 3

| | | | | | | | | Pigment |
|---|---|---|---|---|---|---|---|---|
| | Polymerizable | | Polymerizable | | Crosslinking | | Polymerization | Carbon |
| | Monomer 1 | | Monomer 2 | | Agent | | Initiator | Black |
| | | Added | | Added | | Added | Added | Added |
| Toner | | Amount | | Amount | | Amount | Amount | Amount |
| No. | Type | (Parts) | Type | (Parts) | Type | (Parts) | (Parts) | (Parts) |
| 4 | Styrene | 75.0 | n-butyl | 25.0 | HDDA | 0.2 | 8.0 | 6.5 |
| | | | acrylate | | | | | |
| 5 | Styrene | 75.0 | n-butyl | 25.0 | HDDA | 0.2 | 8.0 | 6.5 |
| | | | acrylate | | | | | |
| 6 | Styrene | 75.0 | n-butyl | 25.0 | HDDA | 0.2 | 8.0 | 6.5 |
| | | | acrylate | | | | | |
| 7 | Styrene | 75.0 | n-butyl | 25.0 | HDDA | 0.2 | 8.0 | 6.5 |
| | | | acrylate | | | | | |
| 8 | Styrene | 75.0 | n-butyl | 25.0 | HDDA | 0.2 | 8.0 | 6.5 |
| | | | acrylate | | | | | |
| 9 | Styrene | 75.0 | n-butyl | 25.0 | HDDA | 0.2 | 8.0 | 6.5 |
| | | | acrylate | | | | | |
| 10 | Styrene | 75.0 | n-butyl | 25.0 | HDDA | 0.2 | 8.0 | 6.5 |
| | | | acrylate | | | | | |
| 11 | Styrene | 75.0 | n-butyl | 25.0 | HDDA | 0.2 | 8.0 | 6.5 |
| | | | acrylate | | | | | |
| 12 | Styrene | 75.0 | n-butyl | 25.0 | HDDA | 0.2 | 8.0 | 6.5 |
| | | | acrylate | | | | | |

| | | | Another | | | | |
|---|---|---|---|---|---|---|---|
| | | | Additive | | | | |
| | Release Agent | | FCA-5 | | | | |
| | | Added | Added | Reaction | | Cooling Condition | |
| Toner | | Amount | Amount | Temperature | Time | Cooling | |
| No. | Type | (Parts) | (Parts) | (° C.) | (hours) | Rate | Annealing |
| 4 | Dipenta- | 35.0 | 2.0 | 76.0 | 6.0 | 10° C./ | Yes |
| | erythritol | | | | | sec | |
| | stearate | | | | | | |
| 5 | Behenyl | 35.0 | 2.0 | 76.0 | 6.0 | 10° C./ | Yes |
| | stearate | | | | | sec | |
| 6 | Dibehenyl | 35.0 | 2.0 | 76.0 | 6.0 | 10° C./ | Yes |
| | sebacate | | | | | sec | |
| 7 | Behenyl | 35.0 | 2.0 | 76.0 | 6.0 | 10° C./ | Yes |
| | behenate | | | | | sec | |
| 8 | Ethylene | 35.0 | 2.0 | 76.0 | 6.0 | 10° C./ | Yes |
| | glycol | | | | | sec | |
| | stearate | | | | | | |
| 9 | Behenyl | 40.0 | 2.0 | 76.0 | 6.0 | 10° C./ | No |
| | stearate | | | | | min | |
| 10 | Behenyl | 40.0 | 2.0 | 76.0 | 6.0 | 10° C./ | Yes |
| | stearate | | | | | sec | |
| 11 | Behenyl | 22.0 | 2.0 | 76.0 | 6.0 | 10° C./ | Yes |
| | stearate | | | | | sec | |
| 12 | Behenyl | 15.0 | 2.0 | 76.0 | 6.0 | 10° C./ | Yes |
| | stearate | | | | | sec | |

TABLE 4

| | | | Endothermic | | | Presence |
|---|---|---|---|---|---|---|
| | | Endothermic | Quantity of Toner | | Proportion of | or |
| | Resistivity | Quantity of | (J/g) | Temperature of | Crystalline | Absence |
| Toner | of Toner | Toner | (within range of | Endothermic | Material in Toner | of Sea- |
| No. | (Ω · m) | (J/g) | 30° C. to 80° C.) | Peak (° C.) | Cross Section | Island |
| 1 | 3.80E+13 | 35 | 35 | 69 | 26 | — |
| 2 | 3.80E+13 | 35 | 35 | 69 | 25 | — |
| 3 | 3.80E+13 | 33 | 33 | 69 | 26 | — |
| 4 | 9.80E+13 | 26 | 24 | 74 | 25 | Present |
| 5 | 1.40E+14 | 24 | 24 | 68 | 26 | Present |
| 6 | 1.70E+14 | 24 | 24 | 70 | 28 | Present |
| 7 | 1.70E+14 | 24 | 24 | 70 | 28 | Present |
| 8 | 9.60E+13 | 28 | 28 | 70 | 26 | Present |
| 9 | 3.00E+13 | 35 | 35 | 68 | — | Absent |
| 10 | 4.90E+13 | 35 | 35 | 68 | 33 | Present |
| 11 | 1.90E+14 | 18 | 18 | 68 | 12 | Present |
| 12 | 2.90E+14 | 15 | 15 | 68 | 9 | Present |

In the table, the resistivity of the toner indicates the resistivity at a frequency of 0.01 Hz, obtained by AC impedance measurement. The value such as “3.80E+13” indicates “3.80×10¹³”.

The proportion of the crystalline material in the toner cross section indicates the area proportion (%) of the crystalline material. The presence or absence of sea-island was determined to be “present” when the amorphous resin and the ester wax form a sea-island structure in the cross section of the toner, and to be “absent” when the amorphous resin and the ester wax forms no sea-island structure. It is to be noted that the presence or absence of sea-island is not confirmed for the toners 1 to 3.

### Production Example of Developing Roller

While this example describes a developing roller for which an elastic roller with an elastic layer provided on the outer surface of a substrate is coated with a resin layer, the present disclosure is not limited to this configuration.

### 1. Preparation of Raw Materials for Resin Layer Formation, and Production

### 1-1. Preparation of Raw Polyol, Production Example

Examples of synthesis for obtaining a polyurethane resin layer will be described below.

### Preparation of Raw Polyol

For A-1 to A-5, which are five types of raw polyols listed in Table 5 below, commercially available products were purchased.

TABLE 5

| No. | Raw Polyol |
|---|---|
| A-1 | DURANOL T5652 Mn = 2000 |
| | (manufactured by Asahi Kasei Chemicals Corporation) |
| A-2 | DURANOL G3452 Mn = 2000 |
| | (manufactured by Asahi Kasei Chemicals Corporation) |
| A-3 | ETERNACOLL UH-200 Mn = 2000 |
| | (manufactured by Ube Industries, Ltd.) |
| A-4 | NIPPOLAN 982 Mn = 2000 |
| | (manufactured by Tosoh Corporation) |
| A-5 | ETERNACOLL UM-90(1:3) Mn = 900 |
| | (manufactured by Ube Industries, Ltd.) |

### 1-2. Preparation of Raw Isocyanates B-1 to B-3

The raw isocyanates listed in Table 6 below were prepared.

TABLE 6

| No. | Raw Isocyanate |
|---|---|
| B-1 | Diphenylmethane diisocyanate (MDI) |
| | (Trade Name: Millionate MT, manufactured by Tosoh Corporation) |
| B-2 | Polymethylene polyphenyl polyisocyanate (polymeric MDI) |
| | (Trade Name: Millionate MR200, manufactured by Tosoh |
| | Corporation) |
| B-3 | Hexamethylene diisocyanate isocyanurate trimer |
| | (Trade Name: DURANATE TPA-100, |
| | manufactured by Asahi Kasei Chemicals Corporation) |

### 1-3. Production Examples of Hydroxyl Group-Terminated Urethane Prepolymers C-1 to C-3

### Synthesis of Hydroxyl Group-Terminated Urethane Prepolymer C-1

Under a nitrogen atmosphere, the following materials were reacted by heating and stirring at a temperature of 90° C. for 3 hours.
raw polyol A-1: 100 parts by mass
raw Isocyanate B-1: 6.3 parts by mass

Thereafter, 2-butanone (MEK) was added to the obtained reaction product to prepare a hydroxyl group-terminated urethane prepolymer C-1 as a solution in which the solid content was 50 parts by mass.

### Synthesis of Hydroxyl Group-Terminated Urethane Prepolymers C-2 to C-3

Hydroxyl group-terminated urethane prepolymers C-2 to C-3 were prepared in the same manner as C-1 with the use of the starting materials listed in Table 7 below.

TABLE 7

| | | |
|---|---|---|
| Hydroxyl Group- | Raw Polyol | Raw Isocyanate |

| Terminated Urethane | | Parts by | | Parts by |
|---|---|---|---|---|
| Prepolymer No. | No. | mass | No. | mass |
| C-1 | A-1 | 100 | B-1 | 6.3 |
| C-2 | A-2 | 100 | B-1 | 6.3 |
| C-3 | A-3 | 100 | B-1 | 6.3 |

### 1-4. Production Examples of Isocyanato Group-Terminated Prepolymers D-1 to D-3

### Synthesis of Isocyanato Group-Terminated Prepolymer D-1

Under a nitrogen atmosphere, the following materials were reacted by heating and stirring at a temperature of 90° C. for 3 hours.
raw polyol A-4: 100 parts by mass
raw Isocyanate B-2: 33.5 parts by mass

Thereafter, 2-butanone (MEK) was added to the obtained reaction product to form a solution in which the solid content was 50 parts by mass, thereby preparing an isocyanate group-terminated prepolymer D-1.

### Synthesis of Isocyanato Group-Terminated Prepolymers D-2 to D-3

Isocyanato group-terminated prepolymers D-2 to D-3 were prepared by the same method as in the case of synthesizing the isocyanato group-terminated prepolymer D-1, with the use of the types and amounts of starting materials listed in Table 8 below.

TABLE 8

| | | |
|---|---|---|
| Isocyanate Group- | Raw Polyol | Raw Isocyanate |

| Terminated | | Parts by | | Parts by |
|---|---|---|---|---|
| Prepolymer No. | No. | mass | No. | mass |
| D-1 | A-4 | 100 | B-2 | 33.5 |
| D-2 | A-5 | 100 | B-3 | 78.4 |
| D-3 | A-3 | 100 | B-2 | 33.5 |

### 2. Preparation of Additive Raw Materials for Resin Layer, and Production

### 2-1. Preparation of Polyoxyethylene Polyoxypropylene Alkyl Ethers E-1 to E-2, Production Examples

### Preparation of Polyoxyethylene Polyoxypropylene Alkyl Ether

For the polyoxyethylene polyoxypropylene alkyl ethers E-1 to E-2 listed in Table 9 below, commercially available products were purchased.

### 2-3. Preparation of Polyoxyethylene Alkyl Ether Acetate, Production Example

### Preparation of Polyoxyethylene Alkyl Ether Acetate

The polyoxyethylene alkyl ether acetate E-3 listed in Table 9 below was purchased synthesized.

### Synthesis of Polyoxyethylene Alkyl Ether Acetate E-3

First, 55.0 g of a polyoxyethylene methyl ether (Trade Name: BLAUNON MP-550, manufactured by AOKI OIL INDUSTRIAL CO., LTD., the average mol number of ethylene oxide added: 12 mol with respect to alcohol) and 510 ml of a 1-mol/l aqueous sodium hydroxide solution were mixed, and with 71.1 g of a potassium permanganate added thereto, stirred at room temperature for 6 hours. Thereafter, the mixture was, with 760 ml of 2-propanol added thereto, stirred for 1 hour to quench the excess potassium permanganate, and the by-product of manganese oxide was further filtered. The aqueous layer was extracted with dichloromethane and purified to obtain E-3, which was a polyoxyethylene methyl ether acetate.

TABLE 9

| No. | Material | Structure | | |
|---|---|---|---|---|
| E-1 | Polyoxyethylene | Formula (2) | R51 = C₄H₉ | t, u = 17 |
| | polyoxypropylene butyl | | | |
| | ether | | | |
| | (Trade Name: UNILUBE | | | |
| | 50MB-26, manufactured | | | |
| | by NOF Corporation) | | | |
| E-2 | Polyoxyethylene | Formula (2) | R51 = C₄H₉ | t = 9, |
| | polyoxypropylene butyl | | | u = 10 |
| | ether | | | |
| | (Trade Name: UNILUBE | | | |
| | 50MB-11, manufactured | | | |
| | by NOF Corporation) | | | |
| E-3 | Polyoxyethylene methyl | Formula (4) | R71 = CH₃ | x = 11 |
| | ether acetate | | | |

### 3. Production Examples of Coating Liquids F-1 to F-17 for Resin Layer Formation

### 3-1. Preparation of Coating Liquid F-1 for Resin Layer Formation

hydroxyl group-terminated urethane polymer C-1: 100 parts by mass
isocyanate group-terminated urethane polymer D-3 54.7 parts by mass
additive E-1: 7 parts by mass
carbon black (Trade Name: MA8, Mitsubishi Chemical Corporation): 35 parts by mass
coarse particle (Trade Name: ART PEARL C-400T, Negami Chemical Industrial Co., Ltd.): 23 parts by mass

The materials mentioned above were added to the inside of a reaction contained and stirred. Next, 2-butanone (MEK) was added thereto such that the total solid content ratio was 30% by mass, and then mixed with a sand mill. Subsequently, 2-butanone (MEK) was added to adjust the viscosity of the liquid within the range of 6 to 10 mPa·s, thereby preparing a coating liquid F-1 for resin layer formation.

### 3-2. Preparation of Coating Liquids F-2 to F-17 for Resin Layer Formation

Coating liquids F-2 to F-17 for resin layer formation were prepared by the following method. First, the hydroxyl group-terminated urethane prepolymer, isocyanate group-terminated prepolymer, additive, carbon black, and coarse particle listed in the Table 10 below were mixed by the same method as in the case of preparing the coating liquid F-1 for a resin layer formation. Thereafter, 2-butanone (MEK) was added to adjust the viscosity of the liquid within the range of 6 to 10 mPa·s, thereby preparing coating liquids F-2 to F-17 for resin layer formation.

TABLE 10

| | Hydroxyl | | Isocyanate | | | | | | | | |
|---|---|---|---|---|---|---|---|---|---|---|---|
| | Group- | | Group- | | | | | | | | |
| | Terminated | | Terminated | | | | | | | | |
| | Urethane | | Urethane | | | | | | Coarse | Ionic Conducting | |
| | Prepolymer | | Prepolymer | | Additive | | Conductive Fine Particle | | Particle | Agent | |
| | | Parts | | Parts | | Parts | | Parts | Parts | | Parts |
| | | by | | by | | by | | by | by | | by |
| | No. | mass | No. | mass | No. | mass | Type | mass | mass | Type | mass |
| F-1 | C-1 | 100 | D-3 | 54.7 | E-1 | 7 | Carbon black (MA8, Mitsubishi Chemical Corporation) | 35 | 23 | — | — |
| F-2 | C-2 | 100 | D-3 | 54.7 | E-1 | 7 | Carbon black (MA8, Mitsubishi Chemical Corporation) | 35 | 23 | — | — |
| F-3 | C-3 | 100 | D-2 | 54.7 | E-1 | 7 | Carbon black (MA8, Mitsubishi Chemical Corporation) | 35 | 23 | — | — |
| F-4 | C-1 | 100 | D-1 | 54.7 | E-1 | 7 | Carbon black (MA8, Mitsubishi Chemical Corporation) | 35 | 23 | — | — |
| F-5 | C-2 | 100 | D-1 | 54.7 | E-1 | 7 | Carbon black (MA8, Mitsubishi Chemical Corporation) | 35 | 23 | — | — |
| F-6 | C-3 | 100 | D-1 | 54.7 | E-1 | 7 | Carbon black (MA8, Mitsubishi Chemical Corporation) | 35 | 23 | — | — |
| F-7 | C-1 | 100 | D-3 | 54.7 | E-1 | 6.6 | Carbon black (MA8, Mitsubishi Chemical Corporation) | 35 | 23 | — | — |
| F-8 | C-1 | 100 | D-3 | 54.7 | E-1 | 16.1 | Carbon black (MA8, Mitsubishi Chemical Corporation) | 35 | 23 | — | — |
| F-9 | C-1 | 100 | D-3 | 54.7 | E-2 | 7 | Carbon black (MA8, Mitsubishi Chemical Corporation) | 35 | 23 | — | — |
| F-10 | C-1 | 100 | D-3 | 54.7 | E-3 | 7 | Carbon black (MA8, Mitsubishi Chemical Corporation) | 35 | 23 | — | — |
| F-11 | C-1 | 100 | D-3 | 54.7 | E-1 | 7 | Antimony-titanium-based oxide | 40 | 23 | — | — |
| | | | | | | | (ET-300W, ISHIHARA SANGYO KAISHA, LTD.) | | | | |
| F-12 | C-1 | 100 | D-3 | 54.7 | E-1 | 7 | Indium-tin-based oxide (Mitsubishi Materials Corporation) | 30 | 23 | — | — |
| F-13 | C-1 | 100 | D-3 | 54.7 | E-1 | 7 | Barium titanate (TFP-NA, TODA KOGYO CORP.) | 43 | 23 | — | — |
| F-14 | C-1 | 100 | D-3 | 54.7 | E-1 | 3 | Carbon black (MA8, Mitsubishi Chemical Corporation) | 43 | 23 | — | — |
| F-15 | C-1 | 100 | D-3 | 54.7 | E-1 | 7 | MA14 (manufactured by Mitsubishi Chemical Corporation) | 35 | 23 | — | — |
| F-16 | C-1 | 100 | D-3 | 54.7 | A-187 | 14 | Carbon black (MA8, Mitsubishi Chemical Corporation) | 35 | 23 | — | — |
| F-17 | C-1 | 100 | D-3 | 54.7 | A-187 | 14 | Carbon black (MA8, Mitsubishi Chemical Corporation) | 35 | 23 | Quaternary | 0.1 |
| | | | | | | | | | | ammonium | |
| | | | | | | | | | | salt | |

A-187 represents a silane coupling agent (Trade Name: A-187, manufactured by Momentive Performance Materials Inc.).

### 4. Production Example of Developing Roller 1

### 4-1. Preparation of Substrate

As a substrate, a core metal made of stainless steel (SUS304) of 6 mm in diameter was prepared by applying a primer (Trade Name: DY35 051, manufactured by Dow Toray Co., Ltd.) to the peripheral surface of the core metal and baking the primer.

### 4-2. Preparation of Elastic Layer

liquid silicone rubber (Trade Name: SE6724A/B, Dow Toray Co., Ltd.): 100.00 parts by mass
carbon black (Trade Name: TOKABLACK #4300, TOKAI CARBON CO., LTD.): 16.00 parts by mass
curing control agent (Trade Name: 1-ethynyl-1 cyclohexanol, Tokyo Chemical Industry Co., Ltd.): 0.01 parts by mass
platinum catalyst (Trade Name: SIP6830.3, GELEST): 0.01 parts by mass

This substrate was disposed in a mold, and an addition-type silicone rubber composition obtained by mixing the materials mentioned above was injected into a cavity formed in the mold.

Subsequently, the mold was heated to vulcanize and then cure the silicone rubber at a temperature of 150° C. for 15 minutes, and after the silicone rubber was demolded, further heated at a temperature of 180° C. for 1 hour to complete the curing reaction, thereby providing an elastic roller with an elastic layer of 11.5 mm in diameter provided on the outer periphery of the substrate.

### 4-3. Preparation of Resin Layer

The elastic roller was held at the upper end thereof with the longitudinal direction of the roller in the vertical direction, and then immersed (dipped) in the coating liquid F-1 for resin layer formation to coat the surface of the elastic layer roller with the coating liquid. The coated product obtained was air-dried at normal temperature for 30 minutes, and then dried in a hot air current-circulating drier set at 160° C. for 1 hour. In this manner, a developing roller 1 with a resin layer of 12 μm in film thickness formed on the elastic layer was obtained. Physical properties of the developing roller 1 are shown in Table 11.

### Production Examples of Developing Rollers 2 to 17

Developing rollers 2 to 17 were prepared in the same manner as in the production example of the developing roller 1 except that the coating material for forming the surface layer of the developing roller was changed to (F-2 to F-17) in the production example of the developing roller 1. Physical properties of the developing rollers 2 to 17 obtained are shown in Table 11.

It is to be noted that the number of elementary processes was one for each of the developing rollers 2-16.

TABLE 11

| | Coating | Physical Properties of Conductive Fine Particle | | | |
|---|---|---|---|---|---|
| | Liquid for | | Primary | DBP | |
| | Resin Layer | | Particle | Absorption | |
| Developing | Formation | | Diameter | Amount | |
| Roller No. | No. | Type | [nm] | [ml/100 g] | pH |
| 1 | F-1 | Carbon black | 24 | 51 | 2.5 |
| 2 | F-2 | Carbon black | 24 | 51 | 2.5 |
| 3 | F-3 | Carbon black | 24 | 51 | 2.5 |
| 4 | F-4 | Carbon black | 24 | 51 | 2.5 |
| 5 | F-5 | Carbon black | 24 | 51 | 2.5 |
| 6 | F-6 | Carbon black | 24 | 51 | 2.5 |
| 7 | F-7 | Carbon black | 24 | 51 | 2.5 |
| 8 | F-8 | Carbon black | 24 | 51 | 2.5 |
| 9 | F-9 | Carbon black | 24 | 51 | 2.5 |
| 10 | F-10 | Carbon black | 24 | 51 | 2.5 |
| 11 | F-11 | Antimony-titanium- | 31 | 30 | — |
| | | based oxide | | | |
| 12 | F-12 | Indium-tin- | 33 | 30 | — |
| | | based oxide | | | |
| 13 | F-13 | Barium titanate | 53 | 30 | — |
| 14 | F-14 | Carbon black | 24 | 51 | 2.5 |
| 15 | F-15 | Carbon black | 40 | 73 | 3 |
| 16 | F-16 | Carbon black | 24 | 51 | 25 |
| 17 | F-17 | Carbon black | 24 | 51 | 25 |

| | | | | | Dispersion State of Carbon Black | | | |
|---|---|---|---|---|---|---|---|---|
| | | | | Maximum | Dispersed Circle- | | Wall-to-Wall | |
| | | | | Value of | Equivalent Diameter | | Distance | |
| Developing | AC Impedance | | | Surface | Mean Rc | | Mean d | |
| Roller No. | Z[Ω] | θ 1 | θ 2 | Potential [V] | [nm] | σc/Rc | [nm] | σd/d |
| 1 | 9.12E+06 | −30 | −80 | 5.7 | 55 | 0.60 | 112 | 0.57 |
| 2 | 8.67E+06 | −30 | −80 | 12.5 | 56 | 0.59 | 109 | 0.57 |
| 3 | 7.41E+06 | −30 | −80 | 14.2 | 52 | 0.60 | 102 | 0.56 |
| 4 | 2.79E+06 | −30 | −80 | 3.2 | 54 | 0.59 | 101 | 0.57 |
| 5 | 1.52E+06 | −30 | −80 | 3.2 | 59 | 0.64 | 104 | 0.55 |
| 6 | 2.36E+06 | −30 | −80 | 3.2 | 58 | 0.61 | 106 | 0.58 |
| 7 | 8.58E+06 | −30 | −80 | 4.5 | 57 | 0.60 | 100 | 0.57 |
| 8 | 6.55E+06 | −30 | −80 | 7.2 | 56 | 0.61 | 101 | 0.56 |
| 9 | 7.71E+06 | −30 | −80 | 6.4 | 57 | 0.61 | 99 | 0.57 |
| 10 | 2.15E+06 | −30 | −80 | 3.8 | 59 | 0.63 | 144 | 0.58 |
| 11 | 9.90E+05 | −30 | −80 | 3.7 | 66 | 0.69 | 85 | 0.59 |
| 12 | 6.91E+06 | −30 | −80 | 4.3 | 59 | 0.62 | 130 | 0.54 |
| 13 | 8.90E+06 | −35 | −78 | 14.8 | 101 | 0.80 | 67 | 0.65 |
| 14 | 8.60E+05 | −15 | −65 | 9.6 | 65 | 0.68 | 79 | 0.65 |
| 15 | 1.59E+04 | −5 | −50 | 8.7 | 104 | 0.77 | 206 | 0.64 |
| 16 | 2.00E+08 | −60 | −80 | 35 | 57 | 0.60 | 113 | 0.57 |
| 17 | 2.00E+08 | −60 | −80 | 46 | 57 | 0.60 | 113 | 0.57 |

The value such as “9.12 E+06” indicates “9.12×10⁶” ˜. The maximum value of the surface potential indicates the maximum value of the potential in the case of charging the outer surface of the developing roller with a corona discharger and measuring the potential of the outer surface after 0.06 seconds from the end of the charging.

### Examples 1 to 28 and Comparative Examples 1 to 7

The following toner evaluation and image evaluation were performed in accordance with the combinations shown in Table 12 with the use of the toners 1 to 12 and developing rollers 1 to 17 described above. In each of examples and comparative examples, the items evaluated are indicated by ∘.

TABLE 12

| | | | Evaluations Performed (◯) | | |
|---|---|---|---|---|---|
| | | | Evaluation | Evaluation | Evaluation |
| | Toner | Developing | of | of | of |
| | No. | Roller No. | Fixation | Stability | Image |
| Example 1 | 1 | 1 | ◯ | ◯ | ◯ |
| Example 2 | 1 | 2 | — | — | ◯ |
| Example 3 | 1 | 3 | — | — | ◯ |
| Example 4 | 1 | 4 | — | — | ◯ |
| Example 5 | 1 | 5 | — | — | ◯ |
| Example 6 | 1 | 6 | — | — | ◯ |
| Example 7 | 1 | 7 | — | — | ◯ |
| Example 8 | 1 | 8 | — | — | ◯ |
| Example 9 | 1 | 9 | — | — | ◯ |
| Example 10 | 1 | 10 | — | — | ◯ |
| Example 11 | 1 | 11 | — | — | ◯ |
| Example 12 | 1 | 12 | — | — | ◯ |
| Example 13 | 1 | 13 | — | — | ◯ |
| Example 14 | 1 | 14 | — | — | ◯ |
| Example 15 | 2 | 1 | ◯ | ◯ | ◯ |
| Example 16 | 3 | 1 | ◯ | ◯ | ◯ |
| Example 17 | 4 | 1 | ◯ | ◯ | ◯ |
| Example 18 | 5 | 1 | ◯ | ◯ | ◯ |
| Example 19 | 6 | 1 | ◯ | ◯ | ◯ |
| Example 20 | 7 | 1 | ◯ | ◯ | ◯ |
| Example 21 | 8 | 1 | ◯ | ◯ | ◯ |
| Example 22 | 9 | 1 | ◯ | ◯ | ◯ |
| Example 23 | 10 | 1 | ◯ | ◯ | ◯ |
| Example 24 | 11 | 1 | ◯ | ◯ | ◯ |
| Example 25 | 5 | 2 | — | — | ◯ |
| Example 26 | 5 | 10 | — | — | ◯ |
| Example 27 | 5 | 14 | — | — | ◯ |
| Example 28 | 1 | 14 | — | — | ◯ |
| Comparative | 12 | 1 | ◯ | ◯ | ◯ |
| Example 1 | | | | | |
| Comparative | 5 | 15 | — | — | ◯ |
| Example 2 | | | | | |
| Comparative | 5 | 16 | — | — | ◯ |
| Example 3 | | | | | |
| Comparative | 5 | 17 | — | — | ◯ |
| Example 4 | | | | | |
| Comparative | 1 | 15 | — | — | ◯ |
| Example 5 | | | | | |
| Comparative | 1 | 16 | — | — | ◯ |
| Example 6 | | | | | |
| Comparative | 1 | 17 | — | — | ◯ |
| Example 7 | | | | | |

Hereinafter, the evaluation methods and evaluation criteria of the present disclosure will be described.

### Method for Evaluating Fixation of Toner

The following evaluations were performed for each of the toners according to Example 1, Examples 15 to 25, and Comparative Example 1.

### Low-Temperature Fixability

A process cartridge (process cartridge for laser beam printer (LBP-712Ci, manufactured by Canon Inc.)) filled with the toner was allowed to stand at 25° C. and a humidity of 40% RH for 48 hours. An unfixed image in an image pattern in which square images of 10 mm×10 mm were evenly arranged at 9 points over the entire transfer sheet was output with the use of a modified machine based on a modified laser beam printer (LBP-712Ci) manufactured by Canon Inc., modified so as to operate even in the case of removing a fixing unit. The toner carrying amount on the transfer paper was set to 0.80 mg/cm², and the fixing onset temperature was evaluated. Further, A4 paper (Plover Bond Paper: 105 g/m², manufactured by Fox River Paper Company) was used as the transfer paper.

As the fixing unit, an external fixing unit was used, which was obtained by removing a fixing unit of a laser beam printer (LBP-712Ci, manufactured by Canon Inc.) to the outside and modified to operate outside the laser beam printer. Further, the external fixing unit increases the fixation temperature by 5° C. from 90° C., and performs fixation under the condition of process speed: 360 mm/s.

The fixed image was visually checked, and with the lowest temperature at which no cold offset was caused as a fixing onset temperature, the low-temperature fixability was evaluated.

### Anti-Hot Offset Property

Under the same conditions as in the evaluation of <1>, the highest temperature at which no hot offset was observed was defined as the highest fixation temperature, and the difference Δ° C. between the highest fixation temperature and the lowest fixation temperature was defined as a fixable region.

### Evaluation of Heat-Resistant Storability of Toner

In a 100 ml resin cup, 5.0 g of the toner was put, and allowed to stand at a temperature of 50° C. and a humidity of 10% RH for 10 days, and then, the degree of agglomeration of the toner was measured in the following manner.

As a measurement apparatus, “Powder Tester” (manufactured by HOSOKAWA MICRON CORPORATION) was used in which a digital display vibrometer “DIGI-VIBRO MODEL 1332A” (manufactured by Showa Sokki Corporation) was connected to a side surface part of a vibration table of the Powder Tester. Further, a sieve of 38 μm in opening size (400 mesh), a sieve of 75 μm in opening size (200 mesh), and a sieve of 150 μm in opening size (100 mesh) were set to be stacked in order from the bottom on the vibration table of the Powder Tester. The measurement was performed in the following manner under an environment at 23° C. and 60% RH.

(1) The amplitude of the vibration table was adjusted in advance such that the displacement value of the digital display vibrometer was 0.60 mm (peak-to-peak).

(2) 5 g of the toner allowed to stand was precisely weighed, and gently placed on the sieve of 150 μm in opening size at the uppermost stage.

(3) After vibrating the sieves for 15 seconds, the mass of the toner remaining on each of the sieves was measured, and the degree of agglomeration was calculated based on the following equation:

degree of agglomeration (%)={(sample mass (g) on sieve of 150 μm in opening size)/5 (g)}×100+{(sample mass (g) on sieve of 75 μm in opening size)/5 (g)}×100×0.6+{(sample mass (g) on sieve of 38 μm in opening size)/5 (g)}×100×0.2

The calculated degree of agglomeration was regarded as the evaluation of the heat-resistant storability.

The results are shown in Table 13. In the case of the toner according to any of the examples, favorable results were obtained in terms of low-temperature fixation, hot offset property, and heat-resistant storability. In contrast, in the case of the toners according to the comparative examples, insufficient low-temperature fixability was obtained.

TABLE 13

| | | Low- | | |
|---|---|---|---|---|
| | Toner | Temperature | Hot Offset | Evaluation of |
| | No. | Fixation [° C.] | [Δ° C.] | Storability |
| Example 1 | 1 | 100 | Δ30 | 23 |
| Example 15 | 2 | 100 | Δ30 | 23 |
| Example 16 | 3 | 110 | Δ30 | 23 |
| Example 17 | 4 | 130 | Δ25 | 23 |
| Example 18 | 5 | 130 | Δ25 | 23 |
| Example 19 | 6 | 130 | Δ25 | 25 |
| Example 20 | 7 | 130 | Δ25 | 21 |
| Example 21 | 8 | 130 | Δ25 | 25 |
| Example 22 | 9 | 130 | Δ15 | 33 |
| Example 23 | 10 | 120 | Δ20 | 22 |
| Example 24 | 11 | 140 | Δ30 | 22 |
| Comparative | 12 | 150 | Δ30 | 23 |
| Example 1 | | | | |

### Evaluation of Developing Apparatus

The following evaluations were performed for each of the developing apparatuses according to Examples 1 to 29 and Comparative Examples 1 to 7.

### Evaluation of Image

The method for evaluating images will be described below.

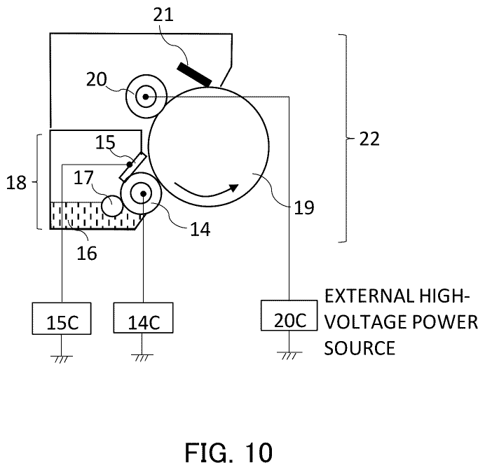

As the electrophotographic image forming apparatus, a modified machine of a commercially available laser printer, LBP-7600C (manufactured by Canon Inc.) was used. FIG. 10 illustrates the construction of the remodified machine. The machine was modified to be connected to an external high-voltage power source 20C in addition to power sources 14C and 15C, such that an arbitrary potential difference is provided between the developing blade and the electrophotographic roller, and for evaluation in a high-speed process, the number of output sheets per unit time was set to 50 sheets/min for paper sheets in A4 size.

In addition, the developing apparatus in the process cartridge was modified in accordance with the combinations of the toners and the developing rollers in Table 12. As the process cartridge, a commercially available toner cartridge 318 (black) (manufactured by Canon Inc.) was used, with the developing roller replaced with each of the developing rollers to be evaluated. In addition, the product toner was replaced with each of the toners to be evaluated. At this time, the filling amount of the toner was adjusted to be 100 g. Further, yellow, cyan, and magenta cartridges were respectively inserted into the yellow, cyan, and magenta stations, with the product toners removed and the remaining toner detection mechanism disabled, and the evaluation was then performed.

### Evaluation of Image Fogging

The prepared process cartridge was installed in the main body of the electrophotographic image forming apparatus, and allowed to stand for 24 hours in an environment at a temperature of 30° C. and a relative humidity of 80% (HH). Thereafter, the potential difference between the developing blade and the electrophotographic roller was set to −150 V with the use of the external high-voltage power source, and in the same environment, an image where an alphabet letter of “E” with a size of 4 points was 2% in print percentage with respect to the area of the A4 size paper sheet was continuously output onto A4 evaluation paper sheets (GF-C081, manufactured by Canon Inc.). After one hundred sheets were output, the sheets were allowed to stand for 24 hours. After allowing the sheets to stand for 24 hours, a solid white image was output on the A4 evaluation paper sheets to evaluate image fogging in accordance with the following evaluation method.

The reflection density R1 of the recording material before image formation and the reflection density R2 of the recording material with the solid white image output thereon were measured with the use of a reflection density meter (Trade Name: TC-6DS/A, manufactured by Tokyo Denshoku Technical Center Co., Ltd.), and the increase in the reflection density (R2-R1) was defined as the “fogging value” of image fogging of the electrophotographic roller. The reflection density was measured over the entire image printing region of the recording material, and the arithmetic mean value was employed for the recording material before image formation, whereas the maximum value was employed for the recording material with the solid white image output.

### Evaluation of Image Density Stability

The prepared process cartridge was installed in the main body of the electrophotographic image forming apparatus, and allowed to stand for 24 hours under an environment at a temperature of 15° C. and a relative humidity of 10% (LL). Thereafter, the potential difference between the developing blade and the electrophotographic roller was set to −300 V with the use of the external high-voltage power source, and one halftone image of 25% with respect to solid black, forty-eight solid white images, and one halftone image of 25% with respect to solid black were continuously output in this order. The densities of the first and fiftieth half-tone images obtained were measured with the use of a spectral densitometer (Trade Name: 508, manufactured by X-Rite, Inc.) to determine the density difference between the first and fiftieth sheets. It is to be noted that the density difference is favorably smaller. The evaluation results are shown in Table 14.

TABLE 14

| | Toner | Developing | Fogging | Image Density |
|---|---|---|---|---|
| | No. | Roller No. | [HH] | Stability [LL] |
| Example 1 | 1 | 1 | 1.3 | 0.04 |
| Example 2 | 1 | 2 | 1.6 | 0.07 |
| Example 3 | 1 | 3 | 1.2 | 0.07 |
| Example 4 | 1 | 4 | 1.2 | 0.02 |
| Example 5 | 1 | 5 | 1.3 | 0.04 |
| Example 6 | 1 | 6 | 1.4 | 0.04 |
| Example 7 | 1 | 7 | 1.0 | 0.04 |
| Example 8 | 1 | 8 | 2.5 | 0.06 |
| Example 9 | 1 | 9 | 1.6 | 0.06 |
| Example 10 | 1 | 10 | 1.6 | 0.04 |
| Example 11 | 1 | 11 | 3.2 | 0.06 |
| Example 12 | 1 | 12 | 1.6 | 0.04 |
| Example 13 | 1 | 13 | 1.6 | 0.15 |
| Example 14 | 1 | 14 | 4.3 | 0.02 |
| Example 15 | 2 | 1 | 1.6 | 0.05 |
| Example 16 | 3 | 1 | 1.4 | 0.04 |
| Example 17 | 4 | 1 | 1.4 | 0.05 |
| Example 18 | 5 | 1 | 1.6 | 0.07 |
| Example 19 | 6 | 1 | 1.4 | 0.04 |
| Example 20 | 7 | 1 | 1.4 | 0.06 |
| Example 21 | 8 | 1 | 1.5 | 0.04 |
| Example 22 | 9 | 1 | 1.6 | 0.05 |
| Example 23 | 10 | 1 | 3.1 | 0.08 |
| Example 24 | 11 | 1 | 1.1 | 0.01 |
| Example 25 | 5 | 2 | 1.8 | 0.04 |
| Example 26 | 5 | 10 | 3.4 | 0.07 |
| Example 27 | 5 | 14 | 4.0 | 0.06 |
| Example 28 | 1 | 14 | 4.1 | 0.04 |
| Comparative | 12 | 1 | 0.9 | 0.00 |
| Example 1 | | | | |
| Comparative | 5 | 15 | 6.7 | 0.05 |
| Example 2 | | | | |
| Comparative | 5 | 16 | 3.1 | 0.28 |
| Example 3 | | | | |
| Comparative | 5 | 17 | 3.0 | 0.35 |
| Example 4 | | | | |
| Comparative | 1 | 15 | 6.8 | 0.07 |
| Example 5 | | | | |
| Comparative | 1 | 16 | 3.4 | 0.30 |
| Example 6 | | | | |
| Comparative | 1 | 17 | 3.3 | 0.34 |
| Example 7 | | | | |

In the case of the toner according to any of the examples, favorable development results were obtained.

In the case of the toner according to Comparative Example 1, the low-temperature fixability was insufficient, while favorable results were obtained in the development evaluation.

In Comparative Examples 2 and 5, the electrical characteristics of the developing roller were close to those of the conductor due to the residence time of the regulating blade and the developing roller, thus causing the charge of the toner to leak, and causing image fogging, and no satisfactory image quality was thus obtained.

In Comparative Examples 3, 4, 6, and 7, the developing roller acted as a high dielectric, thus increasing the electrostatic attachment force between the toner and the developing roller, and resulting in an increase in the amount of the toner that failed to be developed, and insufficient image density stability was obtained.

According to the present disclosure, a developing apparatus with high charge stability, in which a toner that is excellent in low-temperature fixability is used, can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-145555, filed Aug. 27, 2024, which is hereby incorporated by reference herein in its entirety.

What is claimed is:

1. A developing apparatus comprising a developing roller and a toner, wherein
the toner comprises a toner particle comprising a crystalline material,
the toner has a resistivity of not more than 2.00×10¹⁴ Ω·m at a frequency of 0.01 Hz, obtained by AC impedance measurement,
the developing roller comprises a substrate having a conductive outer surface, and a resin layer on the outer surface of the substrate,
the developing roller has an impedance Z of at least 1.00×10⁴ Ω at a frequency of 1.0×10² Hz, obtained by AC impedance measurement,
the developing roller has a phase θ1 of −40° to −10° at a frequency of 1.0×10² Hz, obtained by AC impedance measurement, and
the developing roller has a phase θ2 of not more than −60° at a frequency of 1.0×10⁴ Hz, obtained by AC impedance measurement.

2. The developing apparatus according to claim 1, wherein
an endothermic quantity of the toner, obtained by differential scanning calorimetric measurement, is 20 to 70 J/g.

3. The developing apparatus according to claim 1, wherein
a temperature of an endothermic peak of the toner, obtained by differential scanning calorimetric measurement, is 40° C. to 75° C., and
an endothermic quantity of the toner at 30° C. to 80° C., obtained by differential scanning calorimetric measurement, is 20 to 70 J/g.

4. The developing apparatus according to claim 1, wherein
an area proportion of the crystalline material in a cross section of the toner is not more than 30% when the cross-section of the toner is observed with a scanning transmission electron microscope.

5. The developing apparatus according to claim 1, wherein
the crystalline material comprises at least one selected from the group consisting of a crystalline resin and an ester wax.

6. The developing apparatus according to claim 1, wherein
the crystalline material comprises an ester wax,
the toner particle further comprises an amorphous resin, and
the amorphous resin and the ester wax form a sea-island structure in a cross section of the toner when the cross section of the toner is observed with a scanning transmission electron microscope.

7. The developing apparatus according to claim 1, wherein
the crystalline material comprises a crystalline resin, and
the toner particle further comprises an amorphous resin.

8. The developing apparatus according to claim 7, wherein
the crystalline resin comprises a monomer unit represented by formula (1) below: 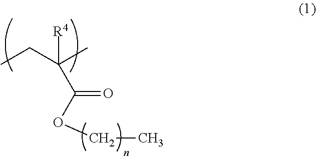
in the formula (1), R⁴ represents a hydrogen atom or a methyl group, and n represents an integer from 15 to 35.

9. The developing apparatus according to claim 8, wherein
the crystalline resin has a lactam structure.

10. The developing apparatus according to claim 8, wherein
the crystalline resin comprises a monomer unit having a five-membered lactam structure.

11. The developing apparatus according to claim 1, wherein
when an outer surface of the developing roller is charged with a corona discharger, and when a potential of the outer surface is measured after 0.06 seconds from end of the charging, a maximum value of the potential is less than 20.0 V.

12. The developing apparatus according to claim 1, wherein
the developing roller has one elementary process obtained from AC impedance measurement from 1.0×10¹ Hz to 1.0×10⁶ Hz.

13. The developing apparatus according to claim 1, wherein
the developing roller comprises a conductive substrate and a resin layer on an outer peripheral surface of the substrate, and
the resin layer comprises a conductive fine particle.

14. The developing apparatus according to claim 13, wherein
when an arithmetic mean of circle-equivalent diameters of the conductive fine particles in the resin layer and a standard deviation of the equivalent circle diameters are denoted, respectively, by Rc and σc,
Rc is not more than 60 nm, and
σc/Rc is 0.00 to 0.65.

15. The developing apparatus according to claim 13, wherein
when an arithmetic mean of wall-to-wall distance of the conductive fine particle in the resin layer and a standard deviation of the wall-to-wall distance are denoted, respectively, by d and ad,
d is 80 to 150 nm, and
σd/d is 0.00 to 0.60.

16. The developing apparatus according to claim 13, wherein
primary particles of the conductive fine particles in the resin layer have a number average diameter of not more than 30 nm.

17. The developing apparatus according to claim 13, wherein
the conductive fine particles comprise at least one selected from the group consisting of a carbon black, an indium-tin-based oxide, and an antimony-titanium-based oxide.

18. The developing apparatus according to claim 13, wherein
the resin layer further comprises a polyurethane.

19. The developing apparatus according to claim 18, wherein
the polyurethane has at least one selected from the group consisting of a polyether structure and a polycarbonate structure.

20. A process cartridge configured to be attachable to and detachable from a main body of an electrophotographic image forming apparatus, wherein
the process cartridge comprises a developing apparatus comprising a developing roller and a toner, wherein
the toner comprises a toner particle comprising a crystalline material,
the toner has a resistivity of not more than 2.00×10¹⁴ Ω·m at a frequency of 0.01 Hz, obtained by AC impedance measurement,
the developing roller comprises a substrate having a conductive outer surface, and a resin layer on the outer surface of the substrate,
the developing roller has an impedance Z of at least 1.00×10⁴ Ω at a frequency of 1.0×10² Hz, obtained by AC impedance measurement,
the developing roller has a phase θ1 of −40° to −10° at a frequency of 1.0×10² Hz, obtained by AC impedance measurement, and
the developing roller has a phase θ2 of not more than −60° at a frequency of 1.0×10⁴ Hz, obtained by AC impedance measurement.

21. An electrophotographic image forming apparatus, comprising a developing apparatus comprising a developing roller and a toner, wherein
the toner comprises a toner particle comprising a crystalline material,
the toner has a resistivity of not more than 2.00×10¹⁴ Ω·m at a frequency of 0.01 Hz, obtained by AC impedance measurement,
the developing roller comprises a substrate having a conductive outer surface, and a resin layer on the outer surface of the substrate,
the developing roller has an impedance Z of at least 1.00×10⁴ Ω at a frequency of 1.0×10² Hz, obtained by AC impedance measurement,
the developing roller has a phase θ1 of −40° to −10° at a frequency of 1.0×10² Hz, obtained by AC impedance measurement, and
the developing roller has a phase θ2 of not more than −60° at a frequency of 1.0×10⁴ Hz, obtained by AC impedance measurement.
